(19) United States
(12) Patent Application Publication
(10) Pub. No.: US 2026/0250030 A1
(43) Pub. Date: Aug. 27, 2026

(54) CUTTING DEVICE AND METHOD FOR APPLYING CUT TRACKS IN AN OUTER PACKAGING

(71) Applicant: TGW Logistics GmbH, Marchtrenk (AT)

(72) Inventors: Stefan HOLZNER, Zaisering (DE); Thomas SCHLOSSER, Frasdorf (DE); Franziska Hildegard SCHNEIDER, Rohrdorf (DE); Michael Kurt ZERWER, Miesbach (DE)

(73) Assignee: TGW Logistics GmbH, Marchtrenk (AT)

(21) Appl. No.: 18/853,299

(22) PCT Filed: Mar. 31, 2023
(86) PCT No.: PCT/AT2023/060108

§ 371 Date: Oct. 1, 2024

(30) Foreign Application Priority Data
Apr. 1, 2022 (AT) A50214/2022

(51) Int. Cl. B65B 69/00; B26D 5/00; B26D 7/01; B26D 7/06; B26D 7/26; B26D 11/00; B65B 57/00

(52) U.S. Cl. CPC B65B 69/0033; B26D 5/007; B26D 7/01; B26D 7/0625; B26D 7/2628; B26D 11/00; B65B 57/00

(57) ABSTRACT

The disclosure relates to a cutting device and a method for applying substantially circumferential cutting paths in an outer packaging in order to cut off a collar and/or a window cutout. The cutting device comprises a first cutting module, which comprises two opposite cutting units, each being movable along a first cutting direction. In addition, the cutting device comprises a control unit for determining a cutting height and for actuating the cutting units, a positioning device for positioning the outer packaging, and a conveying device.

The invention relates to an (automatically operated) cutting device for applying a substantially circumferential cutting path in an outer packaging filled with goods up to a filling level, in particular according to the pre-characterizing portion of claim 1 or 4, wherein the cutting device is configured to apply a first, second, third and fourth cutting path in the outer packaging such that these adjoin one another and form the circumferential cutting path for cutting off a collar and/or window cutout.

Furthermore, the invention relates to a cutting system for an automatically operated cutting device for applying cutting paths in side walls of an outer packaging.

The invention further relates to a method for applying a circumferential cutting path in an outer packaging filled with goods up to a filling level, in particular in side walls and/or a lid of the outer packaging, by means of a cutting device for applying a substantially circumferential cutting path, in particular by means of a cutting device as specified at the above.

In the mail-order business, it is customary for goods to be sent to customers in outer packaging, such as boxes or cardboard boxes. Ordered goods, which comprise one or more piece goods, are filled into an outer packaging with a defined volume for this purpose. An unutilized volume, above the filling level to which the goods in the outer packaging reach, is filled with filling material. On the one hand, oversized outer packaging therefore leads to a higher volume of waste. On the other hand, it takes up more space in a delivery vehicle or in an (interim) warehouse, thus having a higher CO₂ footprint. It is thus desirable to provide a device and a method with which a size of the outer packaging can be adjusted.

In addition, it is customary in warehouse and/or order-picking systems for goods to be delivered in an outer packaging, which must first be opened. This should be as automated and careful as possible, i.e. without damaging the goods.

Various devices are known from the prior art with which a height of the outer packaging can be reduced and/or a lid of the outer packaging can be cut open.

The document U.S. Pat. No. 6,694,852 B1, for example, discloses a cutting device with which an outer packaging can be opened at the top on the one hand, and the collar of the outer packaging can be cut off on the other hand. A plurality of cutting paths are applied in the lid in order to open the outer packaging. The goods are subsequently removed from the opened outer packaging. A circumferential cutting path is applied to the emptied outer packaging by two opposite cutting units, each of which extends to the middle of the outer packaging such that the collar of the outer packaging is cut off. The cut-off collar can be removed and the goods can subsequently be placed back in the outer packaging.

The disadvantage thereof is that cutting off the collar is particularly cumbersome, since the outer packaging must first be opened and the goods removed from the outer packaging before the collar can be cut off. In addition, this can only be done for outer packaging in which the goods can be reliably removed with the gripping device in one gripping operation, for example, because the goods comprise only a single piece good.

The object of the invention is therefore to indicate a cutting device, a cutting system and a method of the type specified at the beginning, with which the collar of the outer packaging can be cut off in an efficient and reliable manner. In particular, it should be possible to cut off the collar without having to remove goods from the outer packaging.

The problem is solved by a device of the type specified at the beginning, wherein the cutting device further has a control unit for determining a cutting height, which is configured to actuate the cutting units such that the circumferential cutting path is applied at the cutting height. The cutting device further has a positioning device, which is configured to position the outer packaging for, in particular simultaneously, applying the first and second cutting path in a first cutting position and for, in particular simultaneously, applying the third and fourth cutting path in a second cutting position.

An advantage achieved with the invention can be seen in particular, on the one hand, in that a height of the outer packaging filled with goods can be reduced, resulting in the provision of volume-optimized outer packaging for shipping, which, on the one hand, reduces the volume of waste generated for the customer and, on the other hand, reduces transport costs. As less space is required of the volume-optimized outer packaging, many outer packagings can be dispatched simultaneously in a transport vehicle, thereby reducing the number of transport operations and thus also improving the CO₂ footprint.

A further advantage achieved by the invention is seen in particular, on the other hand, in that a lid, with which the outer packaging is closed, can be opened. This can be done particularly by also cutting off the lid in that the collar is cut off. Alternatively, the window cutout can be applied in the lid. In this way, the box can be opened automatically and, if necessary, then emptied automatically, as a result of which an increased degree of automation can be achieved, for example, in a storage and order-picking system.

By means of the cutting device, it is in particular possible to apply cutting paths in side walls or a lid of outer packagings, which are of different dimensions and/or are filled to different filling levels.

If the outer packaging has a plurality of side walls, it can preferably be provided that the cutting device is configured to apply the first cutting path in a first side wall of the sidewalls, the second cutting path in a second side wall of the side walls, the third cutting path in a third side wall of the side walls and the fourth cutting path in the fourth side wall of the side walls for cutting off the collar. In this case, the cutting units can be movable parallel to the first cutting direction so that one of the cutting paths can be applied respectively in opposite side walls of the outer packaging.

Furthermore, it is advantageous for the cutting device to be configured to apply the first, second, third and fourth cutting path in the lid for cutting off or cutting out the window cutout. This is particularly expedient if the outer packaging has a lid.

It is favourable for the cutting device to comprise a conveying device for transporting the outer packaging in a conveying direction, wherein the conveying device is configured to move the outer packaging to the first cutting position and/or from the first cutting position to the second cutting position.

It is advantageous for the cutting device to have a second cutting module, which comprises two opposite cutting systems, each having a cutting unit, wherein the cutting units are movable parallel to a second cutting direction such that a respective cutting path of the cutting paths can, in particular simultaneously, be applied in opposite side walls of the outer packaging, wherein the first cutting position is arranged in the region, in particular in the operating region, of the first cutting module and the second cutting position is arranged in the region, in particular of the operating region, of the second cutting module. In this case, the region or operating region of the first or second cutting module is preferably that region, in which the respective cutting units, in particular the cutting elements, can operate or cut. The second cutting module is preferably arranged down-stream of the first cutting module in the conveying direction. Alternatively, the first and second cutting module can be arranged substantially at the same location.

The cutting systems of the first cutting module and/or the second cutting module are preferably positioned opposite one another such that the outer packaging can be positioned substantially between the cutting units of the opposite cutting systems. It is preferably provided that the cutting units of the opposite cutting systems, in particular of the first cutting module and/or of the second cutting module, are each aligned such that their cutting elements are directed toward one another, preferably with the respective cutting edges. As a result, the outer packaging can be positioned between the cutting elements, and the cutting elements can be positioned against opposite side walls of the outer packaging.

The cutting device expediently comprises a first cutting position and a second cutting position. Thus, a first cutting path pair, namely the first and second cutting path, can be applied in the first cutting position and a second cutting path pair, namely the third and fourth cutting path, can be applied in the second cutting position. By applying the cutting paths in different cutting positions, a lesser penetration depth of the cutting elements is required. This makes it possible for the goods to remain in the outer packaging while the collar and, if appropriate, a lid and/or a window cutout in the lid of an outer packaging are cut off, thus reducing the height of the outer packaging and/or opening the outer packaging. This is particularly advantageous if the goods comprise a plurality of articles lying loosely one on top of the other, which cannot be removed in a single gripping operation. Furthermore, it is not necessary to guide the cutting units around the outer packaging, which allows the collar and/or window cutout to be cut off more quickly and reduces the technical complexity of the cutting device.

The cutting elements each particularly preferably comprise one single cutting element.

The positioning device is configured to position the outer packaging in the first cutting position and/or in the second cutting position in order to apply the corresponding cutting paths. Positioning the outer packaging comprises, in particular, centering the outer packaging on the conveying device and/or fixing the outer packaging in place, preferably during the application of cutting paths.

A circumferential cutting path is considered to be a cutting path, which is composed of the first, second, third and fourth cutting path such that this extends along a circumferential surface of the outer packaging formed by the side walls. “Substantially” in this context means that the cutting path can be interrupted in sections, for example at corners of the outer packaging. It is advantageous for the circumferential cutting path and correspondingly the first, second, third and fourth cutting path to extend horizontally.

It is advantageous for the cutting device to be configured such that the first and second cutting path can be applied simultaneously and/or that the third and fourth cutting path can be applied simultaneously. This is made possible by the opposite cutting units, for example.

The outer packaging comprises the first side wall, the second side wall, the third side wall and the fourth side wall, wherein the first and second side wall are opposite and extend parallel to each other, and the third and fourth side wall are opposite and extend parallel to each other. The outer packaging usually comprises a base, from which the side walls project upwards. In addition, the outer packaging can comprise a lid, which closes the outer packaging, in particular on an upper side or on an upper edge of the side walls. The lid can be formed, for example, by folding sections of the side walls or can be placed on the outer packaging as a separate part and, if necessary, connected thereto in a fixed or non-detachable manner, for example adhesively bonded.

The cutting device can be used to process outer packagings of various dimensions. In this case, it can be provided that the outer packagings are individually dimensioned. Alternatively, outer packaging of the same dimensions can be combined to form an outer packaging type. Thus, outer packagings of different outer packaging types can be provided, wherein each outer packaging type is dimensioned differently.

It is advantageous for the outer packaging to be made of a cuttable material, for example cardboard or plastic. The outer packaging is usually configured as a cardboard box or box.

The (cut-off) collar of the outer packaging is considered to be that region of the side walls located above the circumferential cutting path. If the outer packaging is closed at the top, the lid can also be considered as part of the collar.

Furthermore, the (cut-off) window cutout of the outer packaging is considered to be that region in the lid of the outer packaging located inside the circumferential cutting path and/or enclosed thereby. The window cutout is cut out or cut off from the outer packaging by applying the circumferential cutting path such that a window is provided in the lid, through which an inner space of the outer packaging is accessible.

The filling level indicates up to which level the outer packaging is filled with goods. Preferably, the filling level is below an upper edge of the outer packaging. That is, the filling level is usually less than a height of the outer packaging.

The cutting height indicates the height at which the circumferential cutting path is to be applied. In this case, the cutting height can be indicated relative to the base of the outer packaging, or example. For example, the cutting height can be determined when the outer packaging is not yet closed or opened by determining the filling level and setting the cutting height above it, or example. The cutting height is preferably between the filling level and the upper edge of the outer packaging when the circumferential cutting path is to be applied in the side walls, or at the upper edge, in particular at the height of the lid when the circumferential cutting path is to be applied in the lid. Alternatively, however, the cutting height can also be determined when the outer packaging is closed, by determining the height of the lid and/or the upper edge of the outer packaging. In this case, the cutting height can correspond to a height of the outer packaging, for example.

In order to provide a particularly volume-optimized outer packaging, it is preferably provided that the cutting height is determined by the control unit such that the cutting path is applied (as close as possible) above the filling level. However, when opening the outer packaging, it can be provided that the cutting height is determined by the control unit such that the cutting path is applied (as close as possible) below the lid or the upper edge of the outer packaging.

The conveying device enables (automated) transport of the outer packaging towards the first cutting module and, where appropriate, away from the second cutting module.

It is favorable for the conveying device to have a stationary conveyor system and/or a mobile conveyor system. The stationary conveyor system can in particular comprise a roller conveyor and/or a (dual-track) belt conveyor. Furthermore, the mobile conveyor system can in particular comprise autonomously moving conveyor vehicles. Such conveyor vehicles can be controlled by a superordinate control computer. Such conveyor vehicles are also known to the skilled person by the term “automated guided vehicle” (abbreviated to “AGV”) or “autonomous mobile robot” (abbreviated to “AMR”).

The conveying device preferably forms a transport surface, on which the outer packaging rests and can be transported. This transport surface can be provided, for example, by rollers of a roller conveyor, by one or more transport belts of a (dual-track) belt conveyor, by a receiving platform of a conveyor vehicle or the like.

In addition, it is advantageous for the conveying device to have an infeed conveyor section leading to the first cutting module, a cutting module conveying section adjoining the inlet conveying section, and an outfeed conveyor section adjoining the cutting module conveying section and leading away from the first or second cutting module. It is advantageous for the first and/or second cutting module to be arranged in the region of the cutting module conveying section.

The conveying device preferably comprises a roller conveyor or a mobile conveyor system in the infeed conveyor section and in the outfeed conveyor section.

In order to ensure the most precise possible positioning of the outer packaging in the respective cutting positions and reliable transport, it can be provided that the conveying device in the cutting module conveying section comprises a stationary conveyor system, in particular a (dual-track) belt conveyor. In addition, it can be provided that positively acting driving elements are arranged on conveyor belts of the belt conveyor, which can be positioned against a side wall of the outer packaging.

The infeed conveyor section can connect to a conveyor system of a warehouse and/or order-picking system, for example. The conveyor system is configured, for example, to transport the outer packaging filled with goods from an order-picking station to the cutting device, for example. The conveying device is preferably configured to take over the outer packaging from the conveyor system.

Furthermore, the conveyor system of the warehouse and/or order-picking system can connect to the outfeed conveyor section and be configured to transport the outer packaging away from the cutting device, for example to a closing station, at which the outer packaging is closed, or to a decanting station, at which the outer packaging is emptied. The conveying device is preferably configured to transfer the outer packaging to the conveyor system.

In addition, it is advantageous for the outer packaging or outer packagings each to be assigned outer packaging data. Outer packaging data is understood to mean data relating to, in particular describing, the outer packaging. The outer packaging data can comprise data selected from a group comprising an outer packaging identity, an outer packaging dimension, the filling level, a wall thickness of the side walls, a wall thickness of the lid and/or a closed state.

The wall thickness of the side walls can correspond to a distance between an outer side of the side wall and an inner side of the side wall. The wall thickness thus widely corresponds to a single material thickness in sections, in particular cardboard thickness, and/or a double material thickness, if, for example, two material layers, in particular cardboard layers, overlap at least in sections. The same applies to the wall thickness of the lid.

It is favorable for the outer packaging identity uniquely identify an outer packaging or indicate the outer packaging type of the respective outer packaging.

The outer packaging dimension specifies, in particular, a length, width and/or height of the respective outer packaging or outer packaging type.

In addition, the closed state can indicate whether the outer packaging is opened or closed at an upper side by a lid, for example.

It is favorable for the cutting device to comprise an electronic memory. Outer packaging data associated with the outer packagings or the outer packaging types can be stored in the electronic memory. Those outer packaging data stored in the electronic memory can thus be designated as stored outer packaging data.

The control unit can further be configured to determine the cutting height on the basis of the outer packaging data, in particular on the basis of the filling level.

It can optionally be provided that the control unit is connected to the electronic memory, in particular in terms of data, in order to read (stored) outer packaging data from the electronic memory.

It is advantageous for the first and/or second cutting direction to extend horizontally. In addition, it is advantageous for the first cutting direction to extend parallel to the conveying direction or form a 90° angle to the conveying direction in a horizontal plane. The second cutting direction preferably forms an angle between 0° and 90° with the first cutting direction in a horizontal plane. Alternatively, the second cutting direction can extend parallel to or be identical to the first cutting direction.

The first cutting module and/or the second cutting module can be aligned in a longitudinal alignment, in which the first or second cutting direction runs parallel to the conveying direction, or in a transverse alignment, in which the first or second cutting direction runs transverse to the conveying direction. In this context, transverse to the conveying direction means that the cutting direction forms a 90° angle to the conveying direction in a horizontal plane.

In a cutting device with a first and second cutting module, it can be provided that both the first cutting module and the second cutting module are arranged in longitudinal alignment.

It is particularly preferable for the first cutting direction and the second cutting direction, particularly in a horizontal plane, to form a 90° angle. This makes it possible for the circumferential cutting path to be applied without having to be rotate the outer packaging, for example. This can also be achieved by arranging the first cutting module and the second cutting module in a rotated manner, in particular in a horizontal plane, at a 90° angle to one another. Preferably, the first cutting module is aligned in longitudinal alignment and the second cutting module in transverse alignment, or the first cutting module in transverse alignment and the second cutting module in longitudinal alignment. Alternatively, the first cutting module can be rotatable by 90° if no second cutting module is provided, for example.

It is favorable for the cutting units to be configured to apply the respective cutting path with a penetration depth, wherein the penetration depth corresponds to at least one wall thickness of the respective side wall and at most 400%, in particular 200%, of the wall thickness. The penetration depth is considered to be that depth or distance, with which the cutting element penetrates into the outer packaging. On the one hand, a penetration depth that corresponds at least to the wall thickness ensures that the collar and/or window cutout is reliably cut off. On the other hand, the lowest possible penetration depth minimizes the risk of damaging the goods in the outer packaging.

In order to flexibly adapt the cutting device to varying widths or lengths of the outer packaging, it can be provided that a receiving width between cutting units of two cutting systems opposite one another can be changed. In this case, the receiving width indicates a horizontal distance between a first vertical plane, which extends through a cutting unit of a first cutting system of the opposite cutting systems and parallel to the respective cutting direction, and a second vertical plane, which extends through a cutting unit of a second cutting system of the opposite cutting systems and parallel to the respective cutting direction.

Changing the receiving width can particularly be achieved in that cutting units opposite one another are configured such that these are movable horizontally toward one another and away from one another, in order to change, in particular reduce or increase, the receiving width between the cutting units.

The cutting units are preferably continuously movable toward one another or away from one another for this purpose. The cutting device can thus be adapted in a particularly flexible manner to different cardboard widths or cardboard lengths. Alternatively, the cutting elements can be adjustable in defined increments in order to set defined receiving widths. The cutting device can thus be adapted in a particularly fast manner to different cardboard widths or cardboard lengths.

In addition, changing or adjusting the distance between the cutting elements enables regulation of the penetration depth. By doing so, the control unit can be configured to actuate the cutting units or the respective movement devices such that the cutting elements are positioned in such a way that the corresponding penetration depth is reached. With infinitely variable adjustment of the cutting elements, the penetration depth can be adjusted in a particularly variable manner.

It is advantageous for the cutting systems each to have a movement device, on which the respective cutting unit is mounted, wherein the control unit is configured to actuate the movement devices. As a result, the cutting units are movable in an automated manner and a movement of the cutting units can be actuated by the control unit. For this purpose, the first cutting module and/or the second cutting module can each comprise a plurality of, in particular two, movement devices, wherein one movement device respectively is assigned to one respective cutting unit.

The movement devices are preferably configured to move the respective cutting unit in a horizontal plane, in particular parallel to one another. Is favorable for the movement devices of the first cutting module to be configured to move the respective cutting units parallel to the first cutting direction. Furthermore, it is advantageous for the movement devices of the second cutting module to be configured to move the respective cutting units parallel to the second cutting direction.

It is advantageous for the movement devices to each comprise a first, preferably horizontally aligned, linear guide unit, which is aligned parallel to the first cutting direction, along which the respective cutting unit or its respective cutting head is displaceably mounted. If the respective cutting module is arranged in longitudinal alignment, the first linear guide unit also preferably extends parallel to the conveying direction. If the respective cutting module is arranged in transverse alignment, the first linear guide unit can conversely extend transverse to the conveying direction.

In addition, it is favorable for the control unit to be configured to actuate the movement devices such that a receiving width between cutting units of two cutting systems opposite one another is changed.

The movement devices can preferably be configured to move the respective cutting unit in a horizontal plane, in particular toward one another. As a result, as described above, the receiving width can be varied and outer packagings of different widths can be processed with the cutting device. Is favorable for the movement devices of the first cutting module to be configured to move the respective cutting units transverse to the first cutting direction for this purpose. Furthermore, it is advantageous for the movement devices of the second cutting module to be configured to move the respective cutting units transverse to the second cutting direction.

A receiving width required for the respective outer packaging can be comprised in particular by the outer packaging data. In this case, the receiving width is preferably as large as, in particular larger than a width of the outer packaging.

It is advantageous for the movement devices to each comprise a second, preferably horizontally aligned, linear guide unit, which is aligned transverse to the first cutting direction, along which the respective cutting unit or its respective cutting head is displaceably mounted. If the respective cutting module is arranged in longitudinal alignment, the second linear guide unit preferably extends transverse to the conveying direction. If the respective cutting module is arranged in transverse alignment, the second linear guide unit can conversely extend parallel to the conveying direction.

It is advantageously provided that the movement devices are configured to move the respective cutting unit or its respective cutting head along a vertical axis. As a result, the horizontal plane in which the cutting units can move can be substantially adjusted, and thus the cutting height can also be adjusted.

It is advantageous for the movement devices to each comprise a further, preferably vertical aligned, linear guide unit, on which the respective cutting unit or its respective cutting head is vertically displaceably mounted.

It is favourable for at least some of the movement devices to be configured as gantry robots. It can further be provided that at least some of the movement devices are configured as articulated-arm robots.

For example, the movement devices of the first and/or second cutting module can be configured respectively as a gantry robot, which has two, in particular three axes of motion. As described above, the axes of motion can be provided by the first, second and/or further linear guide unit. Alternatively, the movement devices of the first and/or second cutting module can be configured respectively as an articulated-arm robot, for moving the cutting units, in particular the cutting element, along the axes of motion. In this case, the axes of motion can extend or be aligned as described above for the linear guide units.

According to preferred embodiments, it is provided that the movement devices of the first and second cutting module are configured as gantry robots, of the first cutting module as gantry robots and of the second cutting module as articulated-arm robots, of the first cutting module as articulated-arm robots, and of the second cutting module as gantry robots or of the first and second cutting module as articulated-arm robots.

It can further be provided that the second cutting position is in an alignment rotated by an angle of 90° about a vertical axis to the first cutting position, and the conveying device comprises a rotating device for rotating the outer packaging about the vertical axis from the first cutting position to the second cutting position. An alignment of the outer packaging can thus be changed so that the cutting paths can be applied parallel to the same cutting direction, in particular parallel to the first cutting direction. On the one hand, this makes it possible for all four cutting paths to be applied by the first cutting module, meaning that the cutting device can be configured in a particularly compact and therefore space-saving manner. In this case, the rotating device is preferably arranged in the region, in particular in the operating region, of the first cutting module.

Furthermore, the first cutting direction and the second cutting direction can be aligned parallel to one another, in particular in the same direction. The first cutting module and the second cutting module can thus be aligned identically, resulting in a particularly simple construction of the cutting device. In this case, the rotating device can be arranged in the region (operating region) of the first cutting module, in the region (operating region) of the second cutting module and/or between the first cutting module and the second cutting module.

If a first and second cutting module are present, it is advantageous for the conveying device to be configured to transport the outer packaging from the first cutting module to the second cutting module in order to move the outer packaging from the first cutting position to the second cutting position. The outer packaging can thus be transported automatically from the first cutting module to the second cutting module. In this case, it can optionally be provided that the rotating device described above is arranged between the first cutting module and the second cutting module in order to change the alignment of the outer packaging during a movement or transport from the first cutting module to the second.

If two cutting modules are provided, timed operation can be realized, wherein the first and second cutting path are applied in the side walls of a following outer packaging, while a preceding outer packaging is moved to the second cutting module, or while the third and fourth cutting path are applied in the side walls of the preceding outer packaging. As a result, particularly efficient operation of the cutting device can be achieved. In order to ensure smooth operation in this case, it is preferably be provided that the conveying device comprises a buffer device with at least one buffer position between the first and second cutting module, on which an outer packaging can be buffered. For example, the following outer packaging can be buffered until the second cutting module is free of the preceding outer packaging. In order to buffer a plurality of outer packagings, it can be provided that the buffer device has a plurality of buffer positions.

It is favorable for the cutting device to have a detection unit for detecting outer packaging data, the outer packaging data comprising an outer packaging identity, an outer packaging dimension and/or the filling level, in particular an outer packaging opened at an upper side. In this case, an advantage is to be seen in particular in the fact that the device can be flexibly set to different outer packagings without outer packagings having to be provided in a specific sequence or order at the cutting device.

On the one hand, detecting the outer packaging data can take place in that the (stored) outer packaging data are read from the electronic memory by a detection unit and or in that the outer packaging data are determined or measured by the detection unit. Those outer packaging data detected by the detection unit can thus be designated as determined outer packaging data. The detection unit can have a sensor system for this purpose.

It is favorable for the detection unit to be connected to the electronic memory, in particular in terms of data, in order to store the determined outer packaging data in the electronic memory and/or read stored outer packaging data from the electronic memory.

Furthermore, it is advantageous for the detection unit to be connected to the control unit in terms of data in order to transmit the outer packaging data to the control unit. It is favorable for the control unit to be configured to determine the cutting height on the basis of the outer packaging data.

It is particularly preferable for the detection unit to be configured to determine the outer packaging identity of respective outer packaging and to identify the outer packaging or the outer packaging type. Where necessary, the stored outer packaging data assigned to the respective outer packaging identity can be read from the electronic memory by the detection unit or by the control unit.

In order to enable the outer packaging identity to be determined, it can be provided that the sensor system of the detection unit has a reading device for detecting an identification mark arranged on the outer packaging. The reading device can be configured as a reading device for a one-dimensional code, in particular as a bar code scanner, as a reading device for a two-dimensional code, in particular as a QR code scanner, and/or as a reading device for an electromagnetic identification mark, in particular as an RFID scanner. Accordingly, the identification mark can comprise a one-dimensional code, in particular a bar code, a two-dimensional code, in particular a QR code and/or an electromagnetic identification mark, in particular an RFID tag.

Furthermore, the outer packaging dimension specifies a width, length and/or height of the outer packaging. The outer packaging dimension can be present in the form of determined outer packaging data or stored outer packaging data.

In order to enable the outer packaging dimension to be determined, it can be provided that the sensor system of the detection unit is configured to detect a width, a length and/or a height. For this purpose, the sensor system can have one or more light barriers and/or a light curtain, for example.

It can further be provided that the sensor system of the detection unit is configured to determine the filling level in the outer packaging, in particular in an outer packaging opened at the upper side.

It is advantageous for the sensor system to have a camera system, with which an image of the outer packaging, in particular in plan view, can be captured. For this purpose, the camera system is preferably arranged above the conveying device.

It is further favorable for the detection unit to have a computer system, which is configured to determine the filling level and/or the length, the width and/or the height of the outer packaging by means of an algorithm for image recognition, for example.

According to (some) of the aspects described above, the outer packaging or outer packaging type can be identified on the basis of the determined outer packaging identity and, if necessary, its filling level can be determined. The assigned (remaining) stored outer packaging data can be read from the electronic memory by the detection unit or the control unit.

In order to hold the outer packaging in the respective cutting position during the application of the (first and second) cutting path, it can be provided that the positioning device comprises a vertically movable pressing element, in particular by a pressing element drive device, which can be positioned against the outer packaging from above, in particular at an upper edge of opposite side walls, in order to fix the latter in place between the pressing element and a transport surface of the conveying device. As a result, the outer packaging can be held in position during the application of the (first and second) cutting path. The pressing element preferably comprises a horizontally aligned, plate-shaped or rod-shaped pressing element contact element, which can be positioned against opposite side walls of the outer packaging, for example.

It is favorable for the pressing element to be arranged in the region (operating region) of the first cutting module to fix the outer packaging in place during application of the first and second cutting path and, if necessary, during application of the third and fourth cutting path.

The positioning device optionally comprises a (structurally identical) vertically movable pressing element, which is arranged in the region (operating region) of the second cutting module to fix the outer packaging in place during application of the third and fourth cutting path.

In addition, it is favorable for the positioning device to have at least one positioning unit, which comprises two positioning means opposite one another, the positioning means forming contact surfaces facing one another, and the contact surfaces being horizontally movable towards one another and being able to be positioned against opposite side walls of the outer packaging to fix the outer packaging in place between the contact surfaces. As a result, the former can both be fixed in place and centred on the conveying device. In this case, it is advantageous for the positioning means to be horizontally movable toward one another by means of a positioning drive device.

According to a first embodiment of the positioning unit, the positioning means can be movable relative to one another transverse to the conveying direction in order to fix the outer packaging in place between the contact surfaces by clamping.

According to a second embodiment of the positioning unit, the positioning means can be movable relative to one another parallel to the conveying direction in order to fix the outer packaging in place between the contact surfaces by clamping. In this case, a first positioning means of the opposite positioning means can be provided by a vertically adjustable stop element, for example a stop plate. The stop element can be movable, for example, by means of a drive device between an initial position, in particular below the transport surface of the conveying device, and a positioning position, in particular above the transport surface of the conveying device. The stop element preferably comprises a stop surface, wherein the outer packaging, in particular with a front side wall of the side walls in the conveying direction, can be positioned against the first stop surface when the stop clement is in the positioning position. A second positioning element of the opposite positioning means can be provided by a positively acting driving element, which can be positioned against a side wall of the outer packaging, in particular a rear side wall of the side walls in the conveying direction. The driving element can be arranged on conveyor belts of a belt conveyor as described above.

It is favorable for the (first) positioning unit to be arranged according to the first embodiment and/or second embodiment described above in the region of cutting module to fix the outer packaging in place during application of the first and second cutting path and, if necessary, during application of the third and fourth cutting path. In addition, it is favorable for a (second) positioning unit to be arranged according to the first embodiment and/or according to the second embodiment described above in the region of the second cutting module to fix the outer packaging in place during application of the third and fourth cutting path. Alternatively or additionally, it can be provided that a (further) positioning unit is arranged according to the first embodiment and/or according to the second embodiment described above in the region of the detection unit to fix the outer packaging in place during detection of the outer packaging data.

In order to provide better fixing in place, it is preferably provided that at least one contact means is arranged on each of the contact surfaces, wherein said contact means is configured to create a positive and/or frictional connection between the respective positioning means and the respective side wall. The contact means can, for example, comprise a coating to increase the friction coefficient value, for example a coating made of rubber. Alternatively or additionally, the contact means can comprise one or more piercing elements for creating the positive connection, for example projections, needles or the like.

It can be further advantageous for the positioning device to comprise at least one vertically adjustable stop element for example a stop plate. The stop element can be movable by means of a drive device between an initial position, in particular below the transport surface of the conveying device, and a positioning position, in particular above the transport surface of the conveying device. The stop element preferably comprises a stop surface, wherein the outer packaging, in particular with a front side wall of the side walls in the conveying direction, can be positioned against the first stop surface when the stop element is in the positioning position. A (first) stop element is preferably arranged in the region of the detection unit. As a result, a movement of the outer packaging can be stopped precisely in a detection region of the detection unit, in particular of the camera system. It is favorable for a (first or second) stop element to be arranged in the region of the first cutting module. As a result, the movement of the outer packaging can be precisely stopped in the region of the first cutting module, in particular in the first cutting position. It is further advantageous for a (first or further) stop element to be arranged in the region of the second cutting module. As a result, the movement of the outer packaging can be precisely stopped in the region of the second cutting module, in particular in the second cutting position.

It is further advantageous for the cutting device to comprise a lifting device, which has a vertically movable gripping unit for, in particular by means of a gripping unit drive device, lifting the collar and/or the window cutout of the outer packaging. As a result, the cut-off collar and/or window cutout can be lifted and removed automatically. In addition, individual regions along the circumferential cutting path can be severed by tearing if these were not completely severed when applying the cutting path. In this case, the vertical movement of the gripping unit with the collar and/or window cutout upwards is to be substantially regarded as tearing, with the (remaining) outer packaging being retained by the positioning device, for example.

In addition, the gripping unit is preferably configured to be positioned against opposite side walls on the collar and/or on a circumferential edge of the window cutout to fix in place and lift the collar and/or the window cutout in a clamping manner.

The lifting device or its gripping unit can further be used to position the outer packaging in the second cutting position, in that the gripping unit fixes the outer packaging in place during application of the respective cutting paths. In this case, the lifting device can be seen as part of the positioning device.

It is advantageous for the lifting device to be arranged in the region of the second cutting position. This means that the lifting device is arranged in the region of the first cutting module, for example in addition to or instead of the pressing element if only one cutting module is provided, or is arranged in the region of the second cutting module if a first and second cutting module are provided.

It is particularly advantageous for the gripping unit to comprise a plurality of gripping elements, in particular gripping elements at a distance from one another or positionable at a distance from one another. An advantage here can be seen in particular in that a holding force, which is required for lifting the collar and/or the window cutout, can be distributed across the collar or a circumferential of the collar and/or the window cutout and/or a lid of the outer packaging. This enables reliable lifting of the collar and/or the window cutout, regardless of the stability or wall thickness of the outer packaging.

It is further favorable for at least some of the gripping elements, preferably all of the gripping elements, to be movably mounted preferably transverse to the conveying direction in a horizontal plane. On the one hand, this makes it possible for the cut-off collar and/or window cutout to be lifted and, on the other hand, for the lifted collar and/or window cutout to be discharged next to the conveying device. As a result, the cut-off collar and/or window cutout can be disposed of in a simple manner.

In order to grip the side walls with the gripping elements, it can be provided that at least some of the gripping elements, in particular all gripping elements, are configured as clamping grippers. In this case, it can be provided that the first, second, third and/or fourth side wall is clamped by at least one clamping gripper respectively. It is favorable for opposite side walls, in particular those opposite side walls, which are aligned parallel to the conveying direction, and/or those opposite side walls, which are aligned transverse to the conveying direction, to each be fixed in place or clamped by at least one, in particular by a plurality of, clamping grippers

Furthermore, it can be provided that the clamping grippers have two clamping surfaces movable towards one another, wherein on the clamping surfaces, clamping projections and clamping depressions are respectively arranged, which engage one another, when the clamping surfaces are moved towards one another, in particular rest on one another. This improves a connection between the clamping gripper and the respective side wall. For this purpose, the clamping projections can penetrate into the side wall of the outer packaging and, depending on the wall thickness of the side wall, penetrate therethrough, as a result of which, in addition to the clamping force, a positive connection is created between the clamping gripper and the collar and/or window cutout. The lifting can be performed particularly reliably as a result. This is particularly advantageous if individual regions along the circumferential cutting path were not completely severed when applying the cutting path. As described above, the improved connection can ensure reliable severing of these regions by tearing.

Additionally or alternatively to the clamping projections or clamping recesses, it can be provided that the clamping surfaces are respectively provided with a coating to increase the friction coefficient value, for example a coating made of rubber.

It can further be provided that at least some of the gripping elements are configured as needle grippers and/or suction grippers. The needle grippers and/or the suction grippers can be positioned against the side walls and/or the cover in order to create a connection between the gripping elements and the respective side wall and/or the cover. This is particularly advantageous if the outer packaging is closed with a lid.

In order to dispose of the cut-off collar and/or window cutout in a simple manner, it can be provided that the cutting device comprises a disposal device, which is arranged in the operating region of the lifting device, wherein the lifting device is configured to transfer the cut-off collar and/or window cutout to the disposal device. It is favorable for the disposal device to be positioned adjacent to the conveying device and, if horizontally movable gripping elements are provided, positioned such that the horizontally movable griping elements can be positioned above the disposal device. As a result, the cut-off collar and/or window cutout can be discharged to the disposal device by being dropped.

In the simplest case, the disposal device can be provided by a waste receptacle or by a waste chute, into which the cut-off collar and/or window cutout is discharged. Alternatively or additionally, the disposal device can comprise a disposal conveying device. In this case, the cut-off collar and/or window cutout can be discharged to the disposal conveying device and transported away by the latter. A plurality of waste receptacles can be provided, which are arranged such that they can be transported on the disposal conveying device. When a waste receptacle is full, it can automatically be transported by the waste conveying device. The disposal conveying device preferably comprises a belt and/or roller conveyor.

In order to ensure reliable operation, it can be provided that the cutting device comprises a monitoring device, which has a monitoring sensor system for detecting the outer packaging in the first and/or second cutting position, and which is configured to generate a fault message when the outer packaging is moved out of the respective cutting position during application of a cutting path and/or during lifting of a cut-off collar and/or window cutout. This enables an immediate and fast reaction when a fault occurs, thereby avoiding long standstill periods of the cutting device.

The monitoring sensor system preferably comprises a plurality of light barriers, which are arranged in the infeed conveying section, in the cutting module conveying section and/or in the outfeed conveying section. Light barriers are particularly preferably arranged in the region of the first cutting module and/or of the second cutting module in order to detect the presence of the outer packaging during the application of the cutting paths.

Alternatively or additionally, the monitoring sensor can (in each case) have an ultrasonic sensor in the region of the first cutting module and/or the second cutting module, the ultrasonic sensor being arranged below the transport surface of the conveying device and directed upwards or in the direction of the transport surface in order to detect the presence of the outer packaging. It is advantageous for the monitoring sensor system to be constructed analogously to the sensor system of the detection unit described above. The monitoring device can particularly preferably be regarded as part of the detection unit.

It is further advantageous for the monitoring device to have a further monitoring sensor system, which is configured to detect the collar and/or the window cutout during movement of the collar and/or window cutout from the outer packaging. As a result, it is possible to monitor whether the collar and/or window cutout has also been reliably lifted. The further monitoring sensor system can be configured analogously to the monitoring sensor system described above. For example, the monitoring sensor system comprises a light barrier whose light beam crosses a path movement trajectory of the collar and/or window cutout.

When a cutting path is applied in a side wall, the movement of the cutting element along the side wall results in a torque that acts on the outer packaging. It is therefore advantageous for the control unit to be configured to actuate the cutting units such that two opposite cutting units are each moved synchronously. Due to the synchronous movement of the opposite cutting units, the cutting paths are simultaneously applied in opposite side walls, as a result of which the thereby generated torques of the two cutting paths are compensated. As a result, the outer packaging is stabilized during the application of the cutting paths.

In this case, it is particularly provided that the opposite cutting units for applying the first and second cutting path, in particular the cutting units of the first cutting module, are synchronously moved. Similarly, it is preferably provided that the opposite cutting units for applying the third and fourth cutting path, in particular the cutting units of the first or second cutting module, are synchronously moved.

A synchronous movement particularly comprises a simultaneous, uniform and/or rectified movement of the cutting units. In this case, it is not absolutely necessary for any oscillation of the cutting elements to take place synchronously, though this can be optionally provided.

It is favorable for the cutting systems of the cutting device to be configured as described below.

The problem is further solved by a cutting system for an automatically operated cutting device for applying cutting paths in an outer packaging, in particular in side walls and/or a lid of an outer packaging, in particular for a cutting device described above, comprising a movement device and a cutting unit mounted thereon, wherein the cutting unit has a cutting head and a cutting element mounted on the cutting head. In this way, the cutting units can be moved automatically.

It is advantageous for the cutting element to be configured to be vertically adjustable. This enables adjustment of the cutting height. Vertical adjustability of the cutting elements can be achieved in particular in that the cutting elements are mounted on the cutting head so as to be vertically movable and/or the cutting head is vertically movable. The cutting head is vertically movable by means of the movement device, for example.

It is expedient for the cutting head to be mounted on the cutting unit so as to be pivotable about a horizontal axis. As a result, cutting elements can optionally be horizontally aligned for the application of cutting paths in the side walls or vertically for the application of cutting paths in the lid. For this purpose, the cutting head can be brought to a first cutting position, in which the cutting element is aligned horizontally, and into a second cutting position, in which the cutting element is aligned vertically.

The cutting element of the cutting unit expediently comprises a cutting edge. In this case, it is preferably provided that the cutting edge of the cutting element comprises a first cutting section and a second cutting section, wherein the first cutting section is operative when the cutting element moves in the cutting direction, in particular in the first or second cutting direction, and the second cutting section is operative when the cutting element moves counter to the cutting direction, in particular counter to the first or second cutting direction. This enables cutting both in the respective cutting direction and counter to the respective cutting direction. Alternatively, the cutting element can also be configured as a laser cutter.

The first cutting section and the second cutting section are preferably arranged in a horizontal cutting plane. It is further favorable for the first cutting section and the second cutting section to extend inclined toward each other in the horizontal plane to form a tip of the cutting element. It is particularly provided that the first cutting section and the second cutting section form an angle between 0° and 180°, particularly preferably between 0° and 90° for this purpose. It can also be provided that the first cutting section and the second cutting section extend parallel to one another.

Particularly preferably, the first cutting section and the second cutting section are each formed with a grind on both sides, in particular with a flat grind on both sides.

It is advantageous for the cutting head to comprise a connection arrangement, a base body arranged on the connection arrangement, and a cutting element support arranged on the base body, the cutting element being mounted on the cutting element support. As a result, the cutting element can be simply attached to the cutting head. It is particularly preferably provided that the cutting element is replaceably mounted on the cutting element support. If necessary, the base body can be formed in one piece with the connection arrangement.

It is additionally favorable for the cutting unit to comprise a cutting head holder, wherein the connection arrangement is arranged on the cutting head holder. In this case, the connection arrangement can be connected to the cutting head holder or can be formed in one piece therewith. The cutting head holder is particularly preferably arranged on the movement device.

It is further advantageous for the connection arrangement to be mounted on the cutting head holder in a horizontally displaceable manner such that the cutting element can be guided along a cutting path curved on a horizontal plane. As a result, the cutting path can be adapted to a curved surface of the side wall, for example because the side wall is bulged. For this purpose, a curvature can be detected by the detection unit and a curved cutting path can be calculated. The cutting element can then be actively guided along the curved cutting path. Where necessary, this can also be achieved by a targeted actuation of the movement device if the connection arrangement or the cutting head is not movable relative to the cutting head holder.

In order to passively guide the cutting element along the curved cutting path, it can be provided that the cutting head can be displaced from a first position to a second position when the spring force of the return spring is overcome, wherein the return spring is compressed and can be displaced from the second position to the first position when the return spring is decompressed. A position can thus be easily adapted to a bulged sidewall, particularly when the support member described above rests on the sidewall.

It is favorable for the cutting head to comprise a support member, which can be positioned against a side wall of the outer packaging, wherein a normal distance between a vertical tangential plane of a vertex of the cutting element and a contact surface of the support member is constant. As a result, the cutting head can be additionally stabilized during the application of the cutting path on the one hand and the cutting path applied particularly precisely and reliably on the other hand. The support member is preferably on the cutting element support. The vertex of the cutting element can be provided in particular by a vertex of a curved or arcuate cutting element or by a tip of the cutting element.

In addition, the penetration depth can be limited by the support member. The maximum penetration depth is preferably based on a distance between an exposed end of the cutting element and the support member, in particular a contact surface of the support member, with which the support member is positioned against the side wall of the outer packaging. In this case, the exposed end of the cutting element is that end that penetrates into the respective side wall of the outer packaging or into the outer packaging during application of the cutting path.

Furthermore, any bulging or curvature of the outer packaging can be corrected, for example pressed back, by the supporting member in order to ensure as planar a side wall as possible for the application of the cutting path. The quality of the cutting path can thus be improved. As a result, it is also possible to apply cutting paths in side walls of outer packagings, in particular cardboard boxes with low wall thicknesses, thus enabling additional cost and/or material savings since such outer packaging can be used.

It is advantageous for the support member to comprise a first support element and a second support element. Advantageously, the first support element is positioned upstream of the cutting element in the respective cutting direction, and the second support element is positioned down-stream of the cutting element in the respective cutting direction. The first support element section and the second support element are particularly preferably each configured as a support roller, which, in particular with a circumferential surface, can rest on the side wall in a rollable manner. For this purpose, it is preferably provided that the support roller is mounted such that it can rotate about a vertical axis.

Vibrations may be caused during application of the cutting paths, which can lead to increased noise. Mounting the cutting element support on the base body of the cutting head via elastic buffers thus results in an ergonomic advantage. As a result, the vibrations transmitted between the cutting element support and the base body of the cutting head decrease, leading to a reduction in noise.

Furthermore, it is advantageous for the base body to be mounted on the connection arrangement via elastic buffers, for example in order to reduce the transmission of vibrations between the cutting head and the cutting head holder, and in particular the movement device, as described above for the cutting element support. This can be provided, for example, if the cutting element support is not mounted on the base body of the cutting head via elastic buffers. However, this is particularly preferably provided in addition to the elastic buffers of the cutting element support, resulting in a reduction of a transmission of the vibrations substantially in several stages, that is to say by the elastic buffers of the cutting element support and subsequently by the elastic buffers of the cutting head holder.

It can be advantageously provided that the cutting element is movably mounted on the cutting element support and is driven by a cutting element drive device to perform an oscillating movement relative to the cutting head parallel to the (first and/or second) cutting direction. The oscillating movement achieves on the one hand a particularly precise cutting path and on the other hand reduced wear of the cutting edge. In this case, it is particularly advantageous for the cutting edge to have a first and second cutting section as described above so as to be operative both during a forward movement and during a backward movement of the oscillation.

It is also favorable for the cutting element to be movably mounted on the cutting element support and driven by a cutting element drive device to perform an, in particular vertical, oscillating movement relative to the cutting head orthogonal to the cutting direction. The cutting element is thus movable orthogonal to the surface to be cut. The respective cutting path can thus be applied in a jigsaw manner. During a downward movement, the cutting element penetrates into the lid of the outer packaging with a leading penetrating end.

In order to protect the goods inside the outer packaging from damage, it is preferably provided that the cutting element has a rounded, in particular spherical, penetration end.

An oscillating movement is understood to mean a, in particular linear, forward and backward movement of the cutting clement along or orthogonal to the respective cutting direction, for example. In this case, the oscillating movement thus comprises (merely) a longitudinal component, i.e. a movement along the respective cutting direction. Where necessary, the oscillating movement can have a longitudinal component and a transverse component, i.e. a movement transverse to the respective cutting direction, so that the oscillating movement substantially follows an elliptical or circular path.

In this case, it is particularly preferably provided that the cutting element support is mounted on the base body of the cutting head via elastic buffers, as described above, in order to dampen vibrations that occur as a result of the oscillating movement.

It is advantageous for the drive device of the cutting element to also be mounted on the cutting element support. The drive device can thus be arranged in the immediate vicinity of the cutting element. If the cutting element support is mounted on the base body of the cutting head via elastic buffers, as described above, the additional advantage is that vibrations caused by the drive device can also be dampened.

In order to ensure enhanced operational safety, it can be provided that the cutting head comprises a protective cover, which is movable by the adjusting device between an, in particular extended, protective position, in which a cutting edge of the cutting element is covered by the protective cover, and an, in particular retracted, operating position, in which the cutting edge is at least partially exposed. As a result, the cutting element can be covered when the cutting device is not in operation or when no cutting path needs to be applied at that moment. Injuries to operators during maintenance of the cutting device, for example, can thus be prevented. In order to avoid unintentional exposure of the cutting edge, it is favorable for the cutting head to comprise a locking device, by means of which the protective cover can be locked in the protective position.

It is particularly advantageous for the protective cover to be automatically moved from the operating position into the protective position or held in the protective position when the cutting device is not in operation. This can ensure that the protective cover remains in the protective position or is brought into the latter even in the event of a power failure, for example. For this purpose, it is preferably provided that, when the adjusting device is activated, the adjusting device is configured to move the protective cover from the protective position into the operating position overcoming a restraining force, and automatically from the operating position into the protective position when deactivated.

It is favorable for the adjusting device to comprise an contact means, which holds the protective cover in the protective position with restraining force when the adjusting device is deactivated. In this case, the adjusting device is further configured to apply an adjusting force to the adjustment means when the adjusting device is activated, the restraining force being overcome by the actuating force. The adjusting force is preferably greater than the restraining force for this purpose. As a result, the protective cover is moved from the protective position into the operating position when the restraining force is overcome. If the adjusting force ceases or is reduced, for example because the adjusting device is deactivated, the protective cover is automatically moved by the contact means, in particular due to the restraining force, from the operating position into the protective position.

The adjusting device can be configured to be spring-controlled, for example. In this case, the adjustment means can be configured as a tension spring, for example. When the adjustment device is activated, the tension spring is compressed, in particular by means of a drive device of the adjustment device, wherein the adjustment force overcomes a spring force of the tension spring. When the adjustment device is deactivated, the actuating force ceases and the protective cover is automatically moved from the operating position into the protective position when the tension spring is decompressed.

Furthermore, the adjustment device and/or the drive device of the adjustment device can be configured to be fluid controlled, in particular as a pneumatic or hydraulic adjustment device. In this case, a fluid, for example compressed air or a liquid, can be applied to the contact means when the adjusting device is activated. When the adjusting device is deactivated, the fluid can be drained, resulting in the protective cover automatically being moved into the protective position. If appropriate, the adjusting device can be fluid and spring controlled, wherein the adjusting force is generated by application of the fluid.

The problem of the method according to the invention is solved in particular by utilizing the advantages and effects described above, in that the method of the type mentioned at the beginning comprises the following steps:
i) providing the outer packaging at the cutting device,
ii) determining a cutting height, at which the circumferential cutting path is to be applied to the outer packaging, by a control unit,
iii) moving the outer packaging to a first cutting position by a conveying device and positioning the outer packaging in the first cutting position by a positioning device,
iv) actuating opposite cutting systems to apply a first cutting path pair, which comprises a first and a second cutting path, by the control unit, wherein the opposite cutting systems each comprise a cutting unit, each having a cutting element, and wherein the cutting elements are aligned at the determined cutting height,
v) applying, parallel to a cutting direction for applying the first cutting path pair,
the first cutting path in the outer packaging, in particular in a first side wall or a lid of the outer packaging, by the cutting element aligned at the determined cutting height of step iv), the cutting element being of a first cutting system of the opposite cutting systems for applying the first cutting path pair, and
the second cutting path in the outer packaging, in particular in a second side wall or the lid of the outer packaging, by the cutting element aligned at the determined cutting height of step iv), the cutting element being of a second cutting system of the opposite cutting systems for applying the first cutting path pair,
vi) moving the outer packaging from the first cutting position to a second cutting position, in particular by the conveying device, and positioning the outer packaging in the second cutting position by the positioning device,
vii) actuating opposite cutting systems to apply a second cutting path pair, which comprises a third and a fourth cutting path, by the control unit, wherein the opposite cutting systems each comprise a cutting unit, each having a cutting element, and wherein the cutting elements are aligned at the determined cutting height,
viii) applying, parallel to a cutting direction for applying the second cutting path pair,
the third cutting path in the outer packaging, in particular in a third side wall or the lid of the outer packaging, by the cutting element aligned at the determined cutting height of step vii), the cutting element being of a first cutting system of the opposite cutting systems for applying the second cutting path pair, and
the fourth cutting path in the outer packaging, in particular in a fourth side wall or the lid of the outer packaging, by the cutting element aligned at the determined cutting height of step vii), the cutting element being of a second cutting system of the opposite cutting systems for applying the second cutting path pair,
   such that the first, second, third and fourth cutting path result in a substantially horizontally circumferential cutting path, thereby cutting off a collar or a window cutout of the outer packaging,
ix) lifting the cut-off collar or the window cutout of the outer packaging,
x) transporting the outer packaging from the second cutting position after lifting the collar or the window cutout according to step ix) by the conveying device.

An advantage achieved by the method is seen in particular, on the other hand, in that a height of the outer packaging can be reduced in a particularly efficient manner and/or a closed outer packaging opened in a particularly efficient manner.

It is advantageously provided that in step v) the first cutting path is applied in a first side wall of the outer packaging and the second cutting path in a second side wall of the outer packaging, and in step viii), the third cutting path in a third side wall of the outer packaging and the fourth cutting path in a fourth side wall of the outer packaging.

It is optionally provided that in step v), the first and second cutting path, and in step viii) the third and fourth cutting path are respectively applied in the lid of the outer packaging.

Providing the outer packaging at the cutting device in step i) and/or moving the outer packaging into the first cutting position in step iii) takes place, in particular as described above in connection with the conveying device, (automatically) by the conveying device of the cutting device.

Furthermore, moving the outer packaging from the first cutting position to the second cutting position can be achieved by a relative movement between the outer packaging and the cutting elements. Moving in step vi) can be performed thus by a movement of the outer packaging from the first cutting position to a second cutting position by the conveying device. Alternatively, for example, an orientation of the cutting units can be changed, such that the latter are movable first in step v) along the first cutting direction and subsequently in step viii) along the second cutting direction.

The cutting direction for applying the first cutting path pair can be provided by the first cutting direction described above, for example. In the same way, the cutting direction for applying the second cutting path pair can be provided by the first cutting direction or the second cutting direction as described above.

Moreover, determining the cutting height in step ii) and/or actuating in step iv), in particular as described above in connection with the control unit, is performed by the control unit of the cutting device. In this case, the cutting height is expediently selected such that this is at least at the same height as the filling level, in particular above the latter.

If the height of the outer packaging is to be reduced, the cutting height is preferably determined such that the circumferential cutting path is applied (as close as possible) above the filling level. If the outer packaging is to be opened, the cutting height is preferably selected such that the circumferential cutting path is applied (as close as possible) below the lid, in particular immediately below the lid. The cutting height expediently corresponds to the height of the outer packaging minus at least one wall thickness, in particular (at least) 200% of the wall thickness, of the lid. The circumferential cutting path is thus applied directly below the lid.

In steps iv) and vii), the respective cutting systems for applying the first cutting path pair, in particular their movement devices, are actuated such that the cutting elements are aligned at the specific cutting height, in particular relative to the base of the outer packaging.

In steps v) and viii), the cutting paths are preferably applied by moving the cutting units of the respective cutting systems and thus also the cutting elements along the respective cutting direction.

The collar and/or window cutout can be lifted in step ix) in particular by a lifting device described above and optionally comprise discharging the collar and/or window cutout to a disposal device as described above.

In step x), the outer packaging is transported away from the second cutting position by the conveying device and, if necessary, transferred back to the conveyor system of the storage and/or order-picking system.

It is favorable for the cutting device to have a first and/or a second cutting module to perform the method. The first and/or second cutting module can be configured as described above.

The method is particularly preferably performed by means of a cutting device, which is configured according to one of the aspects described above.

It is favorable for the outer packaging to be rotated about a vertical axis by an angle of 90° by a rotating device of the conveying device during the movement of step vi). This is particularly advantageous if the first and second cutting positions are aligned at a rotation of 90° to one another and are thus characterized by a different orientation of the outer packaging.

It is advantageous for the same cutting systems to be used in steps iv), v), vii) and viii), in particular the cutting systems of the first cutting module of the cutting device. Both the cutting systems for applying the first cutting path pair and those for applying the second cutting path pair can thus be identical and formed by the cutting systems of the first cutting module.

Alternatively, it can be provided that the outer packaging is moved by the conveying device from the first cutting module to a second cutting module during the movement of step vi). For this purpose, it can be provided that the first cutting module comprises the cutting systems for applying the first cutting path pair and the second cutting module the cutting systems for applying the second cutting path pair.

In order to realise timed operation of the cutting device, it can be provided that steps i) to x) are performed for a preceding outer packaging and for a following outer packaging, wherein step iii) is performed for the following outer packaging when the first cutting module is free of the preceding outer packaging. A particularly high throughput can thus be achieved.

It can further be provided that steps i) to x) are performed for a preceding outer packaging and for a following outer packaging, wherein step vi) is performed for the following outer packaging when the second cutting module is free of the preceding outer packaging, or wherein the following outer packaging in step vi) is buffered on a buffer position of a buffer device between the first and second cutting module until the second cutting module is free of the preceding outer packaging. This ensures that there is no blockage or jam in the cutting device as the following outer packaging is only moved further when there is space for it in the conveying direction.

In order to ensure that the collar and/or window cutout are reliably cut off and, if necessary, goods in the outer packaging are not damaged, it can be provided that the cutting paths in steps v) and viii) are applied with a penetration depth of the respective cutting element of at least one wall thickness of the respective side wall and a maximum of 400%, in particular 200%, of the wall thickness.

In order to enable efficient and flexible processing of outer packagings of differing dimensions and/or outer packagings filled to differing filling levels, it is advantageous for determining the cutting height in step ii) to comprise detecting outer packaging data (described above) by means of a detection unit, after which the outer packaging data are transmitted to the control unit. As described above, detecting the outer packaging data can comprise determining outer packaging data by the detection unit as well as reading stored outer packaging data from the electronic memory.

It is further advantageous for the outer packaging and/or the outer packaging type to be identified in step ii) on the basis of the detected outer packaging data and for the outer packaging data assigned to an outer packaging identity and stored in an electronic memory to be read. In this case, it is favorable for at least the outer packaging identity to be determined as described above, for example on the basis of an identification mark. The stored outer packaging data preferably comprises the outer packaging dimension and/or the filling level. As a result, no additional sensor systems are required to detect the outer packaging dimension and/or the filling level, for example.

In addition, it is favorable for the outer packaging data to comprise the filling level and/or an outer packaging dimension, in particular a height of the outer packaging, and in step ii), for the filling level and/or the outer packaging dimension to detected, after which the cutting height is selected such that it is at least at the same height as the filling level or at a height above the filling level and/or below an upper edge of the outer packaging and/or at the height of the lid of the outer packaging. The filling level can be detected in that it is read from the electronic memory.

Alternatively, the filling level can be determined by the detection unit as described above. An advantage achieved thus is seen in particular in that an actual filling level can be detected and the cutting height adjusted if necessary. This is particularly advantageous if the filling level changes during transport of the outer packaging by the conveying device or the conveyor system of the storage and/or order-picking system, in particular due to the outer packaging being shaken during this and the goods thus moving in the outer packaging.

In order to secure the outer packaging against twisting during application of the cutting paths, it is favorable for positioning of the outer packaging in steps iii) and/or vi) to comprise fixing the outer packaging in place, wherein a vertically movable pressing element of the positioning device is positioned against the outer packaging from above in order to fix the outer packaging in place between the pressing element and a transport surface of the conveying device.

It can alternatively or additionally be provided that positioning the outer packaging in steps iii) and/or vi) comprises fixing the outer packaging in place, wherein opposite side walls of the outer packaging are fixed in place in a clamping manner between two positioning means of the positioning device. Positioning can be performed in particular as described above in connection with the positioning device.

It is particularly preferably provided that, as described above in connection with the lifting device, lifting the cut-off collar and/or window cutout in step ix) is automated, wherein the collar and/or the window cutout is gripped by a gripping unit of a lifting device and lifted by a vertical movement of the gripping unit. In this case, it can be advantageous for the vertical movement to comprise a vertical component, that is to say a movement component in the vertical direction, and optionally a transverse component, that is to say a movement component in the horizontal direction, in particular transverse to the conveying direction.

If not all regions along the circumferential cutting path were severed during application of the cutting paths, it can be provided that lifting the cut-off collar and/or window cutout in step ix) comprises severing regions along the circumferential cutting path that were not severed when the cutting paths were applied in steps v) and viii) by tearing. This can take place as described above in connection with the lifting device. Tearing off the cut-off collar and/or window cutout can take place particularly reliably if the vertical movement comprises a vertical component and a transverse component.

Furthermore, it is advantageous for the outer packaging to be retained when the collar and/or window cutout is lifted in step ix). This is preferably performed by the positioning means of the positioning device.

Utilizing the advantages and effects described above, it can be provided that the cutting elements of the cutting units are moved in an oscillating manner parallel to the respective cutting direction when the cutting paths are applied. The oscillating movement can be performed as described above in the form of a linear movement or along a circular or elliptical path.

In order to ensure increased operational safety, it can be provided that a cutting edge of the cutting elements is respectively covered by a protective cover in a protective position while the respective cutting unit is not in use, and the protective cover is moved from the protective position to an operating position in which the cutting edge is exposed by activating an adjusting device, wherein the adjusting device is activated when the respective cutting unit is used to apply a cutting path. It is preferably provided that the protective cover is moved back into the protective position when the adjusting device is deactivated. This preferably takes place when a cutting operation is ended, the cutting device is switched off or when maintenance is carried out on the cutting device. Moving the protective cover can take place in particular as described above. The protective cover is particularly preferably locked in the protective position by a locking device.

Utilizing the advantages and effects described above, it can in particular be provided that the cutting units are actuated by the control unit such that cutting heads of the cutting units or cutting systems for applying the first and second cutting path in step v), in particular during application of the first cutting path pair, are moved (translationally) synchronously parallel to the cutting direction for applying the first cutting path pair, in particular along the first cutting direction, and cutting heads of the cutting units or cutting systems for applying the third and fourth cutting path in step viii), in particular during application of the second cutting path pair, are moved (translationally) synchronously parallel to the cutting direction for applying the second cutting path pair, in particular along the second cutting direction. This can take place in particular as described above.

The figures below elaborate on the invention to offer better understanding thereof.

Each show in greatly simplified depiction:

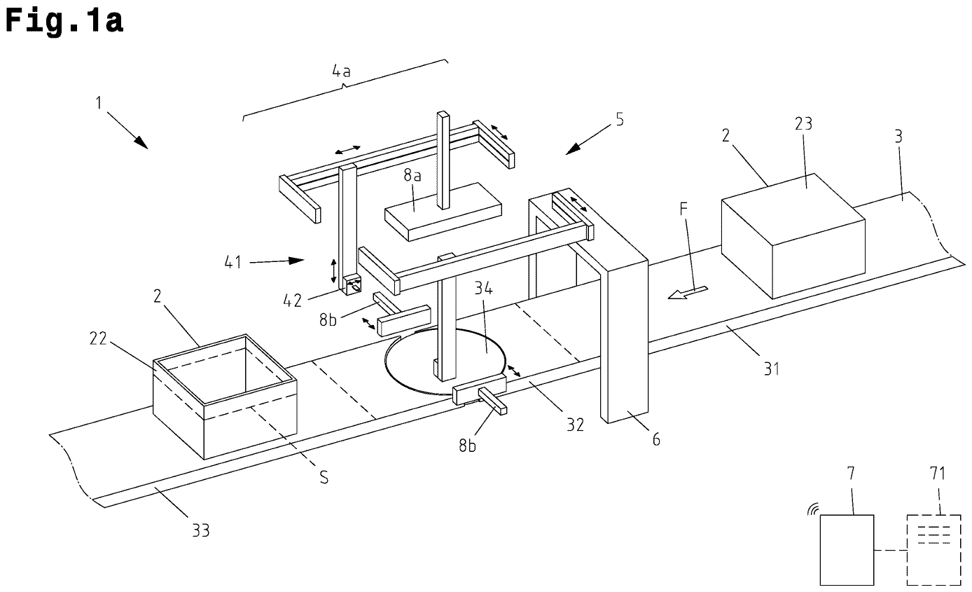

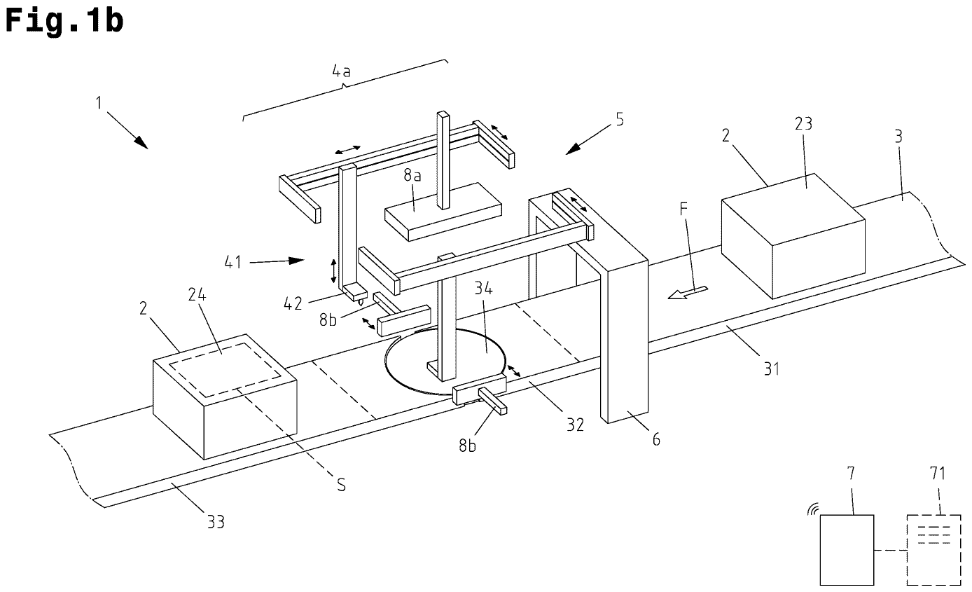

FIGS. 1a and 1b a cutting device,

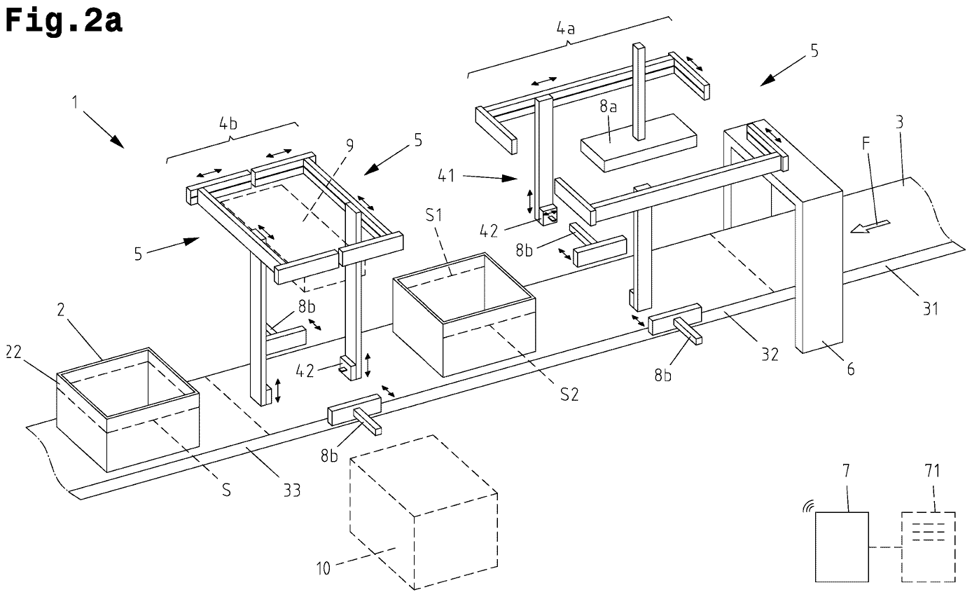

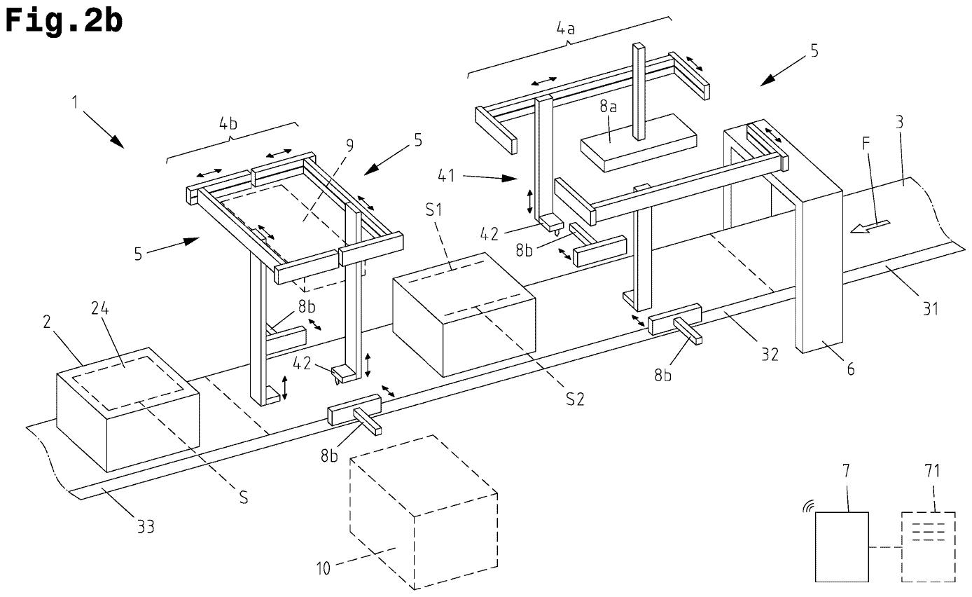

FIGS. 2a and 2b the cutting device in an alternative embodiment,

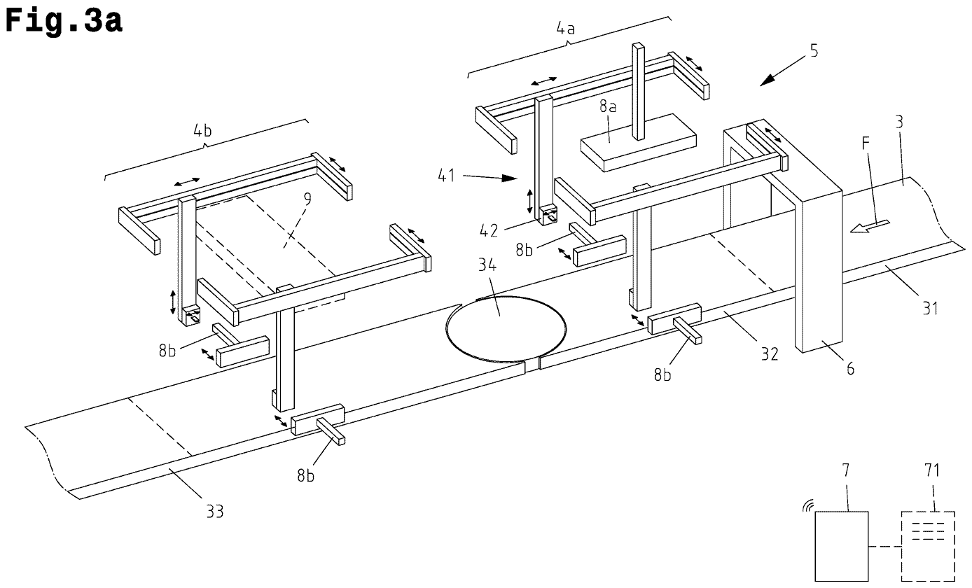

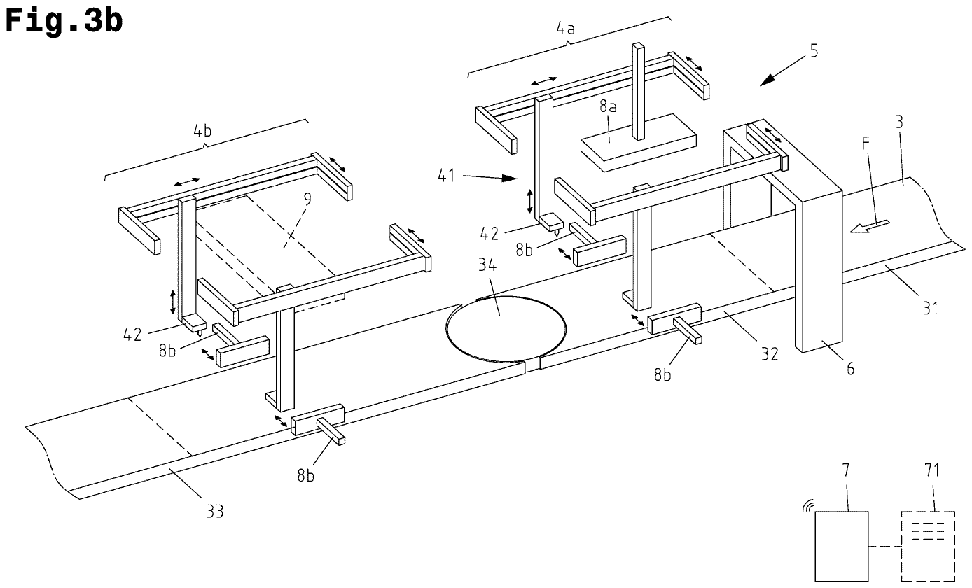

FIGS. 3a and 3b the cutting device in a further alternative embodiment,

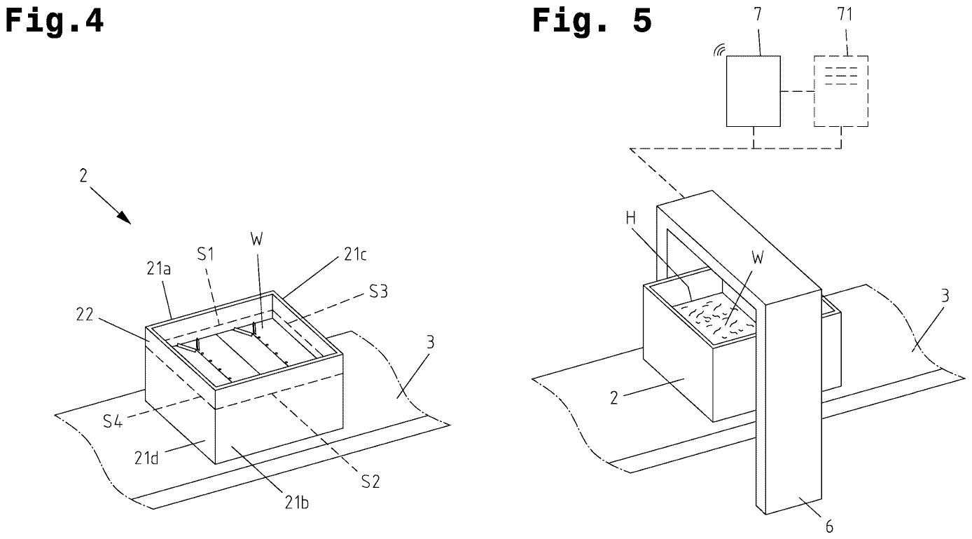

FIG. 4 an outer packaging,

FIG. 5 a detection unit of the cutting device,

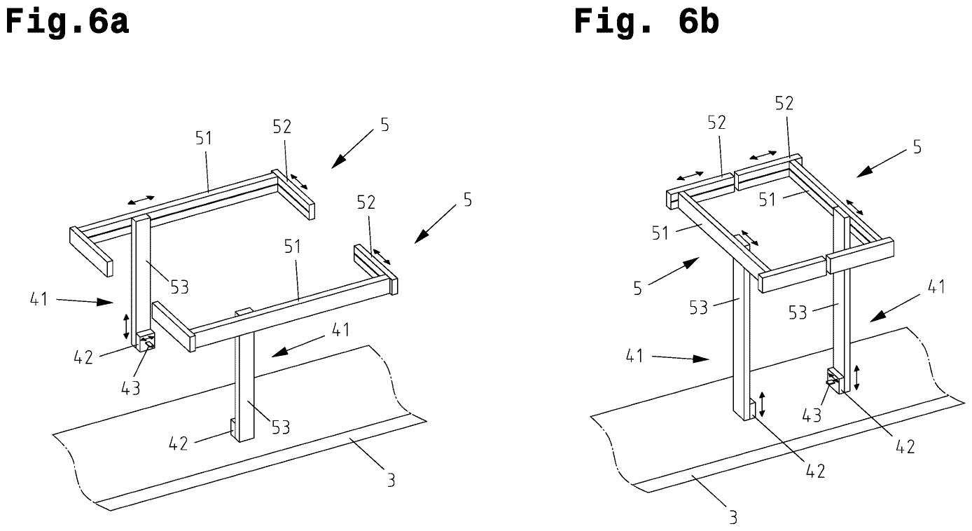

FIGS. 6a, 6b a movement device for moving cutting units,

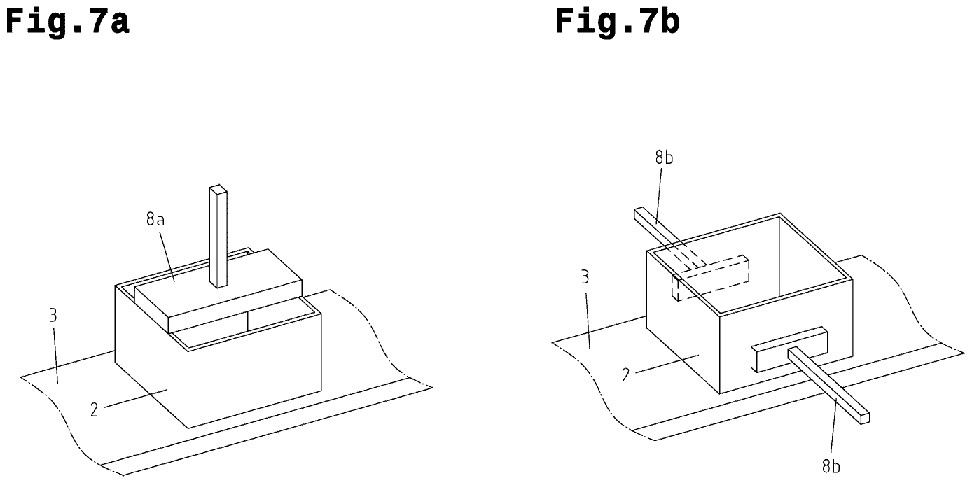

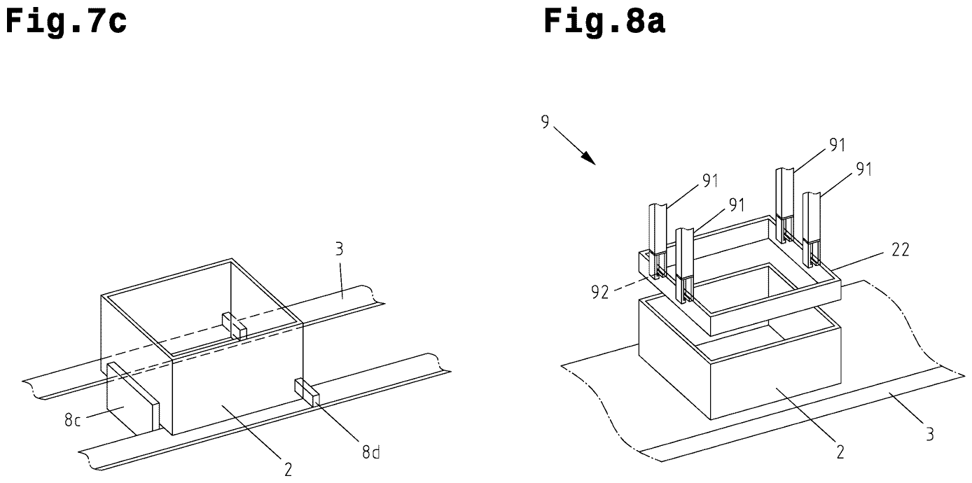

FIG. 7a to 7c a positioning device for positioning the outer packaging,

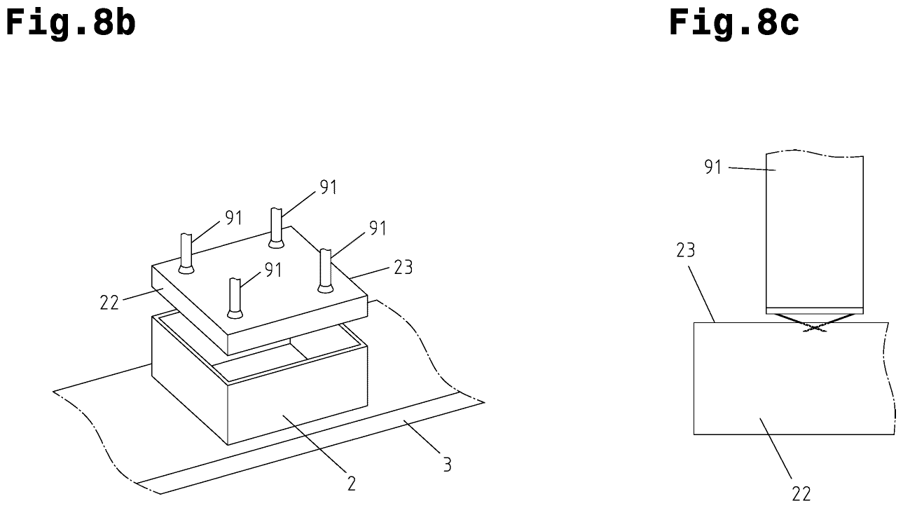

FIG. 8a to 8c a lifting device of the cutting device,

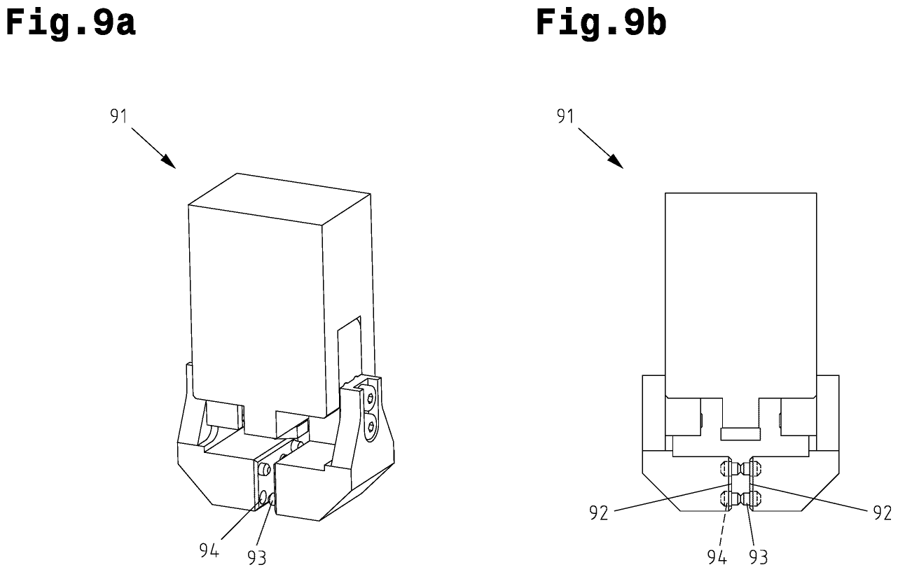

FIGS. 9a, 9b a clamping gripper of the lifting device,

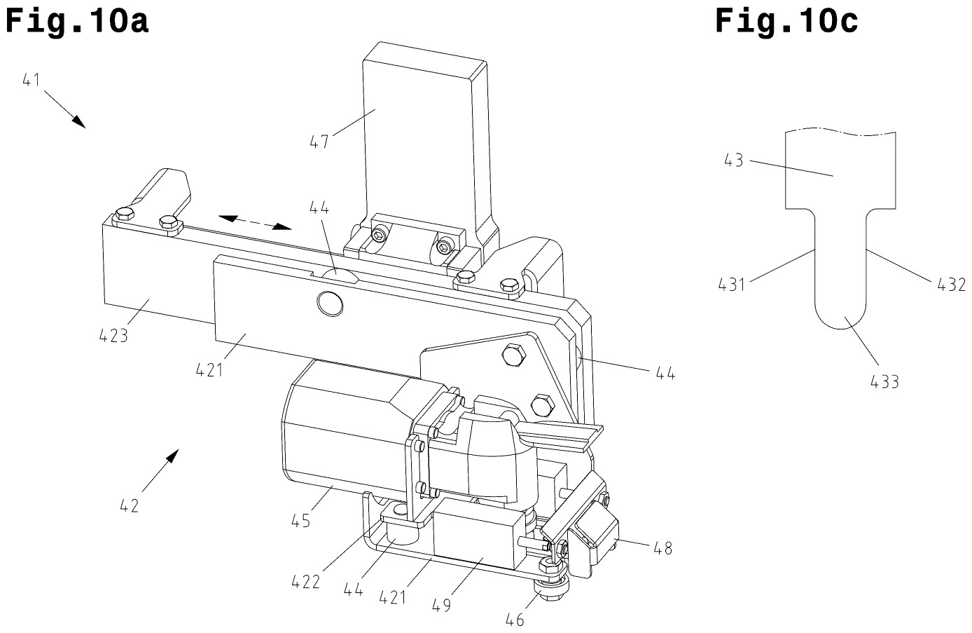

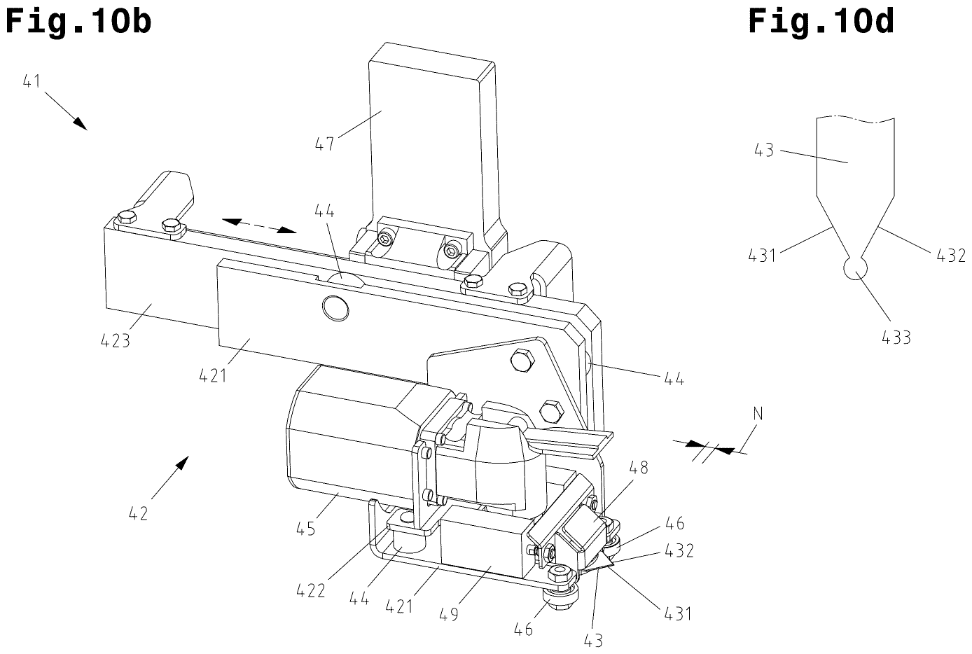

FIGS. 10a, 10b a detailed view of the cutting unit,

FIGS. 10c, 10d a cutting element with a rounded penetration end,

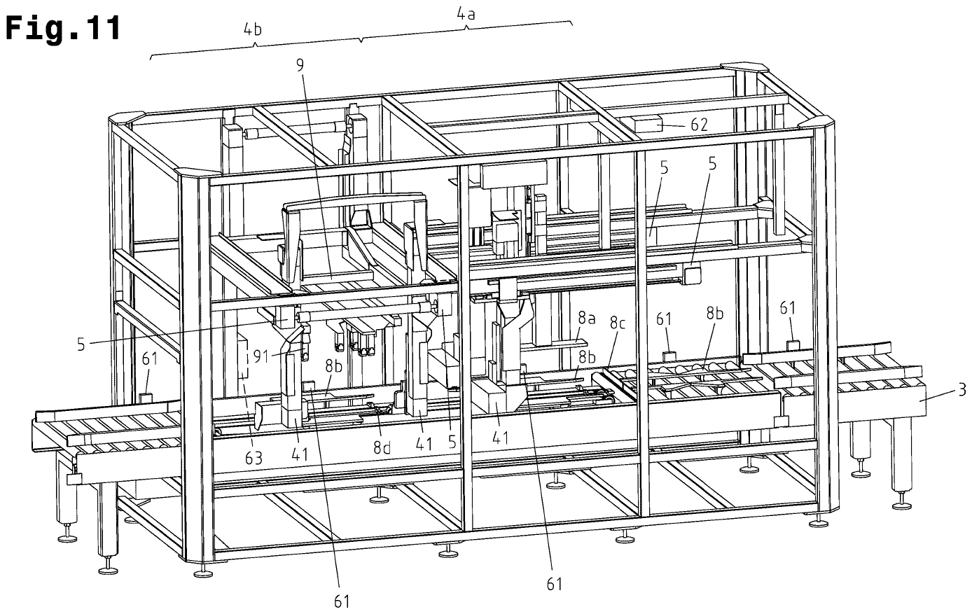

FIG. 11 a perspective view of the cutting device,

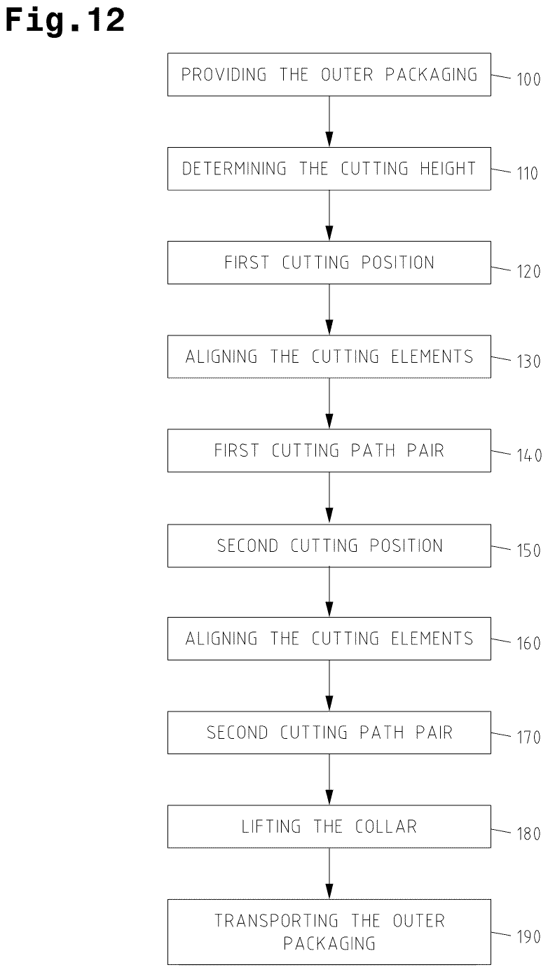

FIG. 12 a method for applying a circumferential cutting path.

It is worth noting here that the same parts have been given the same reference numerals or same component designations in the embodiments described differently, yet the disclosures contained throughout the entire description can be applied analogously to the same parts with the same reference numerals or the same component designations. The indications of position selected in the description, such as above, below, on the side etc. also refer to the figure directly described and shown, and these indications of position can be applied in the same way to the new position should the position change.

FIG. 1a to 3b each show a simplified schematic illustration of a cutting device 1, which is configured to apply a circumferential cutting path S in an outer packaging 2.

The cutting device 1 comprises a first cutting position, in which a first cutting path S1 and a second cutting path S2 can be applied, as well as a second cutting position, in which a third cutting path S3 and a fourth cutting path S4 can be applied. The cutting paths S1 . . . S4 adjoin one another in order to form the circumferential cutting path S. As a result, a collar 22 and/or a window cut-out 24 of the outer packaging 2 is cut off.

As shown by way of example in FIG. 1a, FIG. 1b and FIG. 2b, the outer packaging 2 can have a lid 23, which closes the outer packaging 2 is closed at the top.

In order to transport the outer packaging 2 along a conveying direction F, in particular from an infeed side to an outfeed side of the cutting device 1, the cutting device 1 can comprise a conveying device 3, which can further be configured to move the outer packaging 2 from the first cutting position to the second cutting position. In the depictions shown, in particular in FIG. 1a to FIG. 8b and in FIG. 11 respectively, the conveying direction F substantially extends from right to left.

If necessary, the conveying device 3 can comprise a stationary conveyor system and/or a mobile conveyor system. The stationary conveyor system can in particular comprise a roller conveyor and/or a (dual-track) belt conveyor.

As indicated by dashed lines, the conveying device 3 can have an infeed conveying section 31 leading to the first cutting module 4a, a cutting module conveying section 32 adjoining the inlet conveying section 31, and an outfeed conveying section 33 adjoining the cutting module conveying section 32 and leading away from the first cutting module 4a or second cutting module 4b.

In this case, it can be provided that the conveying device 3 comprises a roller conveyor in the infeed conveying section 31 and in the outfeed conveying section 33 respectively and a (dual-track) belt conveyor in the cutting module conveying section 32.

The cutting devices 1 shown in FIG. 1a to FIG. 3b each comprise a first cutting module 4a. As illustrated in FIG. 1a, FIG. 2a and FIG. 3a, the first cutting module 4a can be configured for applying cutting paths S1 . . . S4, S in opposite side walls 21a . . . 21d of the outer packaging 2. As illustrated in FIG. 1b, FIG. 2b and FIG. 3b, the first cutting module 4a can alternatively or additionally be configured for applying cutting paths S1 . . . S4, S in the lid 23 of the outer packaging 2. The first cutting module 4a advantageously comprises two opposite cutting systems, each of which having a cutting unit 41.

As shown in FIG. 2a, FIG. 2b, FIG. 3a, and FIG. 3b, the cutting device 1 can additionally comprise a second cutting module 4b, which is downstream of the first cutting module 4a in the conveying direction F. As illustrated in FIG. 2a and FIG. 3a, the second cutting module 4b can be configured for applying cutting paths S in opposite side walls 21a . . . 21d of the outer packaging 2. As illustrated in FIG. 2b and FIG. 3b, the second cutting module 4b can alternatively or additionally be configured for applying cutting paths S1 . . . S4, S in the lid 23 of the outer packaging 2. Analogously to the first cutting module 4a, the second cutting module 4b comprises two opposite cutting systems for this purpose, each of which having a cutting unit 41.

Furthermore, the cutting units 41 each have a cutting head 42 and a cutting element 43 mounted on the cutting head 42. The cutting head 42 can be mounted on the cutting unit 41 so as to be pivotable about a horizontal pivot axis, such that the former can be moved from the orientation shown in FIG. 1a, FIG. 2a, and FIG. 3a, in which the cutting element 43 is horizontally aligned for applying cutting paths S1 . . . S4, S in the side walls 21a . . . 21d, to the orientation shown in FIG. 1b, FIG. 2b, and FIG. 3b, in which the cutting element 43 is vertically oriented for applying cutting paths S1 . . . S4, S in the lid 23.

As shown in FIG. 1a to FIG. 3b, the first cutting module 4a is preferably oriented parallel to the conveying direction F or provided in a longitudinal alignment such that a first cutting direction extends parallel to the conveying direction F. Alternatively, the first cutting module 4a can be provided in a transverse alignment, in which the first cutting direction forms a right angle with the conveying direction F in a horizontal plane. This is not explicitly depicted.

As shown in FIG. 2a and FIG. 2b, the second cutting module 4b can be oriented transverse to the conveying direction F or provided in a transverse alignment such that a second cutting direction forms a right angle with the conveying direction F in a horizontal plane. As shown in FIG. 3a and FIG. 3b, the second cutting module 4b can alternatively be provided in the longitudinal alignment such that the second cutting direction extends parallel to the conveying direction F.

The cutting units 41 can be moved parallel to the respective cutting direction. This means that the cutting units 41 of the first cutting module 4a are movable parallel to the first cutting direction and the cutting units 41 of the second cutting module 4b parallel to the second cutting direction.

If only the first cutting module 4a is provided, as is shown by way of example in FIG. 1a and FIG. 1b, the first cutting position and the second cutting position are arranged in the region of the first cutting module 4a. In this case, it is provided that the outer packaging 2 is aligned longitudinally to the conveying direction F in the first cutting position and transversely to the conveying direction F in the second cutting position.

For this purpose, it can be provided that the conveying device 3 comprises a rotating device 34, with which the outer packaging 2 can be moved by 90° about a vertical axis from the first cutting position to the second cutting position. The rotating device 34 is arranged in the region of the first cutting module 4a for this purpose. Thus, the first cutting path S1 and the second cutting path S2 can be applied in a first step, the outer packaging 2 rotated in a second step and the third cutting path S3 and the fourth cutting path S4 applied in a third step. In this case, the cutting paths S1 . . . S4 can be applied by the first cutting module 4a. In this case, the first and second cutting path S1, S2 and the third and fourth cutting path S3, S4 are applied along the first cutting direction, In other words, the first and second cutting direction are identical in this case.

If the second cutting module 4b is also provided in addition to the first cutting module 4a, as shown by way of example in FIG. 2a, FIG. 2b, FIG. 3a and FIG. 3b, the first cutting position is in the region of the first cutting module 4a and the second cutting position in the region of the second cutting module 4b.

In this case, the conveying device 3 is configured to move the outer packaging 2 from the first cutting module 4a to the second cutting module 4b. Thus, the first cutting path S1 and the second cutting path S2 can be applied by the first cutting module 4a in the first step, the outer packaging 2 moved from the first cutting module 4a to the second cutting module 4b in the second step and the third and fourth cutting path S4 applied by the second cutting module 4b in the third step.

On the one hand, it can be provided that the first cutting module 4a and the second cutting module 4b are oriented to one another at a rotation of 90° so that the orientation of the outer packaging 2 need not be changed. For this purpose, as shown in FIG. 2a and FIG. 2b, the first cutting module 4a can be provided in longitudinal alignment and the second cutting module 4b in transverse alignment, or vice versa, as is not explicitly shown. In this case, the outer packaging 2 is aligned longitudinally to the conveying direction F in both the first cutting position and in the second cutting position.

On the other hand, it can be provided that the first cutting module 4a and the second cutting module 4b are identically oriented such that the outer packaging 2 has to be rotated as descried above for FIG. 1a and FIG. 1b. As shown in FIG. 3a and FIG. 3b, the first cutting module 4a and the second cutting module 4b can be provided in longitudinal alignment for this purpose. In this case, it is provided that the outer packaging 2 is aligned longitudinally to the conveying direction F in the first cutting position and transversely to the conveying direction F in the second cutting position. The first cutting module 4a and the second cutting module 4b can alternatively be provided in transverse alignment, as not explicitly shown. In this case, it can be provided that the outer packaging 2 is aligned transversely to the conveying direction F in the first cutting position and longitudinally to the conveying direction F in the second cutting position.

In order to rotate the outer packaging 2 between the first cutting module 4a and the second cutting module 4b, the conveying device 3 itself can comprise a rotating device 34, which is arranged between the first cutting module 4a and the second cutting module 4b, for example,

In order to move the cutting units 41, it can be provided that the cutting systems each have a movement device 5, which is assigned to the respective cutting unit 41. The cutting units 41 are mounted on the respectively assigned movement device 5. The movement devices 5 are further configured in particular as described below in connection with FIG. 6a and FIG. 6b.

In addition, the cutting device 1 can have a detection unit 6, in particular upstream of the first cutting module 4a, which is described in more detail in connection with FIG. 5. The detection unit 6 is configured to detect outer packaging data. The detection unit 6 is not essential, in particular if the outer packaging data are known, for example from a flow of goods or an outer packaging sequence, with which the outer packaging 2 is provided.

In addition, the cutting device 1 comprises a control unit 7, which is configured, on the one hand, to determine the cutting height and, on the other hand, to actuate the cutting systems or cutting units 41, in particular the respective movement devices 5, such that the circumferential cutting path S is applied at the determined cutting height. If a movement device 5 is provided, it is favorable for the control unit 7 to be connected thereto in order to actuate it.

It is further advantageous for the control unit 7 to be connected to the detection unit 6 in terms of data, as is explained in more detail in particular in connection with FIG. 5.

The cutting 1 unit optionally comprises an electronic memory 71, which is connected to the control unit 7 and/or the detection unit 6 in terms of data. Outer packaging data can be stored in the electronic memory 71. These are designated as stored outer packaging data.

In order to position and/or fix the outer packaging 2 in place in the respective cutting position, the cutting device 1 comprises a positioning device 8a, 8b, which is described in further detail with reference to FIG. 7a and FIG. 7b below.

In order to automatically lift the cut-off collar 22 and/or window cutout 24, it can be provided that the cutting device 1 comprises a lifting device 9. The lifting device 9 is preferably arranged in the region of that cutting module 4a, 4b, with which the third and fourth cutting path S3, S4 are applied. For the sake of clarity, the optional lifting device 9 is shown only with dashed lines in FIG. 2a, FIG. 2b, FIG. 3a and FIG. 3b. Of course, this can also be provided in the cutting device 1 shown in FIG. 1a and FIG. 1b. The lifting device 9 is described in more detail below in connection with FIG. 8a to FIG. 8c.

In addition, the cutting device 1 can comprise an optional disposal device 10, to which the cut-off collar 22 and/or window cutout 24 can be transferred. The optional disposal device 10 is shown by way of example in FIG. 2a and FIG. 2b for various embodiments of the cutting device 1 but can also be provided in connection with other embodiments of the cutting device 1.

It can further be provided that the conveying device 3 can comprise a buffer device, which is arranged between the first cutting module 4a and the second cutting module 4b, and in which the outer packaging 2 can be buffered.

FIG. 4 shows the outer packaging 2, wherein it is clear that the first and second side wall 21a, 21b and the third and fourth side wall 21c, 21d are opposite each other in pairs. The first and second cutting path S1, S2 are arranged in the first and second side wall 21a, 21b and the third and fourth cutting path S3, S4 in the third and fourth side wall 21c, 21d. The cutting paths S1 . . . S4 are applied at the same cutting height such that these form the circumferential cutting path S. The region above the circumferential cutting path S is designated as the (cut-off) collar 22. If necessary, the outer packaging 2 can comprise a lid 23. The lid 23 is illustrated by way of example in one of the outer packagings 2 in FIG. 1a and in the outer packagings 2 in FIG. 1b and FIG. 2b. As shown in FIG. 1b and FIG. 2b, a window cutout 24 can be cut off instead of the (cut-off) collar 22 by applying the circumferential cutting path S in the lid 23 such that the inside of the outer packaging 2 is accessible via a window.

In principal, the outer packaging 2 is filled up to a filling level H with goods W, for example with garments of clothing, shoe boxes or the like. As shown in FIG. 4, the filling level is below an upper edge of the outer packaging 2. Furthermore, the cutting height is preferably selected such that it is above the filling level H.

FIG. 5 shows the detection unit 6 in a schematic and greatly simplified manner. It is favorable for this to have a sensor system, which is configured to detect outer packaging data.

If the outer packaging identity is to be detected, for example, it can be provided that the sensor system has a reading device for detecting an identification mark arranged on the outer packaging 2.

As shown by way of example in FIG. 11, it can be alternatively or additionally provided that the sensor system has a light curtain and/or one or more light barriers 61 in order to detect the outer packaging dimension.

It can further be provided that the sensor system has a camera system 62, with which an image of the outer packaging 2 in plan view can be captured. In this case, it can be provided that the detection unit 6 has a computer system, which is configured to determine the outer packaging dimension and/or the filling level H by means of an algorithm for image recognition from the captured image. As is shown by way of example in FIG. 11, the camera system 62 can be arranged above the conveying device 3.

It is further favorable for the detection unit 6 to be connected to the control unit 7 and/or to the electronic memory in terms of data. The outer packaging data detected or determined by the detection unit 6 can thus be transferred to the control unit 7 and/or stored in the electronic memory.

The detection unit 6 can further be configured to read outer packaging data that is stored and that is stored and assigned to the outer packaging identity from the electronic memory 71, for example the outer packaging dimension and/or filling level H. The outer packaging data can subsequently be transferred from the detection unit 6 to the control unit 7.

FIG. 6a and FIG. 6b each show a schematic depiction of two opposite cutting systems. In the example shown, the cutting systems each comprise a movement device 5, on each of which a cutting unit 41 is mounted. The movement devices 5 of the two opposite cutting systems are identical and, in particular, configured in a mirrored manner in a vertical plane. In this case, the cutting heads 42 of the cutting systems can be aligned as shown in FIG. 1a, FIG. 2a, FIG. 3a, FIG. 6a, and FIG. 6b, or as shown in FIG. 1b, FIG. 2b, and FIG. 3b. The cutting heads 42 can optionally be mounted on the respective cutting unit 41 so as to be pivotable, as described above.

If the (first and/or second) cutting module 4a, 4b is arranged in a longitudinal alignment, the movement devices 5 of the respective cutting module 4a, 4b can be aligned such that the respective cutting direction extends parallel to the conveying direction F. This is shown in FIG. 6a. Alternatively, the movement devices 5 of the respective cutting module 4a, 4b can be aligned such that the respective cutting direction extends transverse to the conveying direction F, in particular if the (first and/or second) cutting module 4a, 4b is arranged in transverse alignment. This is shown in FIG. 6b.

The movement devices 5 can preferably comprise a first linear guide unit 51, on which the cutting unit 41 is movably mounted parallel to the respective cutting direction. This is indicated by a double arrow parallel to the first linear guide unit 51 in FIG. 6a and FIG. 6b.

If outer packagings 2 of varying width are to be processed with the cutting device 1 or a window cutout 24 of varying width is to be applied, it can additionally be provided that the cutting units 41 are movable toward one another in a horizontal plane such that a distance or a receiving width between the cutting units 41 can be changed. For this purpose, the cutting units 41 are movable transverse to the conveying direction F as shown in FIG. 6a, or parallel to the conveying direction F as shown in FIG. 6b, as indicated by corresponding double arrows. For this purpose, the movement devices 5 can each comprise a second linear guide unit 52, on which the first linear guide unit 51 is displaceably mounted. However, this is not essential if only outer packagings 2 of the same width are to be processed with the cutting device 1.

In order to adapt a cutting height, the cutting heads 42 or the cutting units 41 respectively can be vertically movable, as indicated by a vertical double arrow in FIG. 6a and FIG. 6b. This need not be the case if the same cutting height is always determined, for example in order to shorten outer packagings 2 to a uniform height, or if the conveying device 3 is configured to be height adjustable. If the cutting elements 43 are to be vertically moved, the movement device 5 can additionally comprise a further linear guide unit 53, on which the cutting unit 41 or the cutting head 42 is displaceably mounted.

FIG. 7a schematically depicts a pressing element 8a of the positioning device. The pressing element 8a is vertically movable and, as shown in FIG. 7a, can be positioned against top edges of opposite side walls 21a . . . 21d to fix the outer packaging 2 in place between a transport surface of the conveying device 3 and the pressing element 8a.

As shown in FIG. 1 to FIG. 3, the pressing element 8a can be arranged in the region of the first cutting module 4a in order to fix the outer packaging 2 in place in the first cutting position. A further such pressing element 8a can optionally be arranged in the region of the second cutting module 4b.

FIG. 7b schematically depicts a positioning unit of the positioning device. The positioning unit comprises two opposite positioning means 8b that are horizontally movable toward one another. As indicated in FIG. 7b, the positioning means 8b with contact surfaces can be positioned against opposite side walls 21a . . . 21d of the outer packaging 2 in order to fix the latter in place on the one hand and to center the same on the conveying device 3 on the other hand.

In addition, FIG. 7c schematically depicts a further positioning unit of the positioning device. The positioning unit shown comprises two positioning means movable relative to one another, which are thus also movable toward one another. In this case, a first positioning means is configured as stop element 8c. In this case, the stop element 8c can be movable by means of a drive device between an initial position, in particular below a transport surface of the conveying device 3, and a positioning position, in particular above the transport surface of the conveying device 3. The stop element 8c can be vertically movable or arranged on a belt revolving about two horizontal axes for this purpose. In this case, a second positioning means comprises positively acting driving elements 8d, which can be positioned against a side wall of the outer packaging 2. The driving elements 8d are arranged on the conveying device 3, in particular on conveyor belts of the conveying device. As can be seen in FIG. 7c, the outer packaging 2 can be fixed in place in a clamping manner between the stop element 8c and the driving element 8d or the driving elements 8d when the stop element 8c is in the positioning position.

As shown in FIG. 1 to FIG. 3, it is favorable for a positioning unit to be arranged respectively in the region of the first cutting module 4a and/or in the region of the second cutting module 4b. The positioning unit in the region of the first cutting module 4a can optionally be omitted if a pressing element Sa is provided. A further such positioning unit can optionally be arranged in the region of the detection unit 6.

FIG. 8a to FIG. 8c schematically depict a vertically movable gripping unit of the lifting device 9, with which the collar 22 and/or the window cutout 24 of the outer packaging 2 can be automatically lifted.

The gripping unit depicted comprises a plurality of gripping elements 91, wherein at least some of the gripping elements 91 are configured as clamping grippers, as suction grippers and/or as needle grippers.

As shown in FIG. 8a, the clamping grippers are configured such that a side wall can be clamped between clamping surfaces 92 of the clamping gripper.

Furthermore, the suction grippers can be configured such that these can be positioned against the lid 23 of the outer packaging 2, in particular against the window cutout 24, and grip the latter by applying a vacuum as shown in FIG. 8b. The suction grippers can alternatively also be positioned against side walls 21a . . . 21c.

FIG. 8c shows a needle gripper, wherein needles of the needle gripper can substantially pierce into the lid 23 of the outer packaging 2, in particular into the window cutout 24, in order to grip the latter. The needle gripper can also be arranged such that its needles can pierce the side wall.

Some of the gripping elements 91 or all of the gripping elements 91 of the gripping unit are preferably horizontally movable in order to discharge the cut-off collar 22 or the window cutout 24 next to the conveying device 3 and to transfer this, for example, to the disposal device 10.

FIG. 9a and FIG. 9b show a gripping element 91, which is configured as a preferred variant of a clamping gripper.

The clamping gripper comprises two clamping surfaces 92 movable toward one another in the variant shown. Clamping projections 93 and clamping depressions 94, which can engage one another, are respectively arranged on the clamping surfaces 92.

FIG. 10a and FIG. 10b show a preferred embodiment of the cutting unit 41, wherein the cutting head 42 in FIG. 10a is shown in a protective configuration, in which a cutting edge of the cutting element 43 is covered, and in FIG. 10b in an operating configuration, in which the cutting edge is exposed.

The cutting head 42 shown comprises a base body 421 and a cutting element support 422, on which the cutting element 43 is mounted, mounted on the base body 421. The cutting element support 422 is preferably mounted on the base body 421 via elastic buffers 44. In addition, the cutting head 42 shown comprises a connection arrangement 423, wherein the base body 421 is mounted on the connection arrangement 423 via elastic buffers 44.

The cutting element 43 is further movably mounted on the cutting element support 422 and driven by a cutting element drive device 45 to perform an oscillating movement relative to the cutting head 42, parallel to the respective cutting direction. In the example shown, the cutting element drive device 45 is also arranged on the cutting element support 422.

Furthermore, the cutting head 42 depicted comprises a support member 46, which is mounted on the cutting element support 422. In the example shown, the support member 46 has a first support element and a second support element, each of which is configured to be roller shaped and can be positioned against a side wall in a rollable manner.

It is further provided, for example, that the cutting units 41 each comprise a cutting head holder 47, wherein the cutting head 42, in particular the base body 421 or the connection arrangement 423, is attached to the cutting head holder 47. In this case, it can be provided that the cutting head 42 is mounted on the cutting head holder 47 so as to be horizontally movable as indicated by a dashed double arrow in FIG. 10a and FIG. 10b.

The cutting element 43 comprises a cutting edge, which has a first cutting section 431 and a second cutting section 432 in the example shown. The cutting sections 431, 432 are arranged in a horizontal cutting plane and preferably form an acute angle such that they form a tip of the cutting element 43.

A protective cover 48 can be provided in order to cover the cutting edge in the protective configuration while the respective cutting element 43 is not being used. The protective cover 48 is movable by an adjusting device 49 between a protective position shown in FIG. 10a, in which the cutting edge is covered by the protective cover 48, and an operating position shown in FIG. 10b, in which at least part of the cutting edge is exposed or not covered by the protective cover 48. As shown in FIG. 10a and FIG. 10b, both the protective cover 48 and the adjusting device 49 can be mounted on the cutting element support 422.

As shown in FIG. 10b, a normal distance N between a vertical tangential plane of a vertex of the cutting element 43 and a contact surface of the support member 46 is preferably constant.

Alternatively, the cutting head 42 can be substantially configured as a lifting blade, wherein the cutting element 43 is movably mounted on the cutting element support 422 and driven by the cutting element drive device 45 to perform an oscillating movement relative to the cutting head 42, orthogonal to the respective cutting direction.

In order to protect the goods W inside the outer packaging 2 from damage from the cutting element 43, it can be provided that the cutting element 43 is configured with a rounded penetration end 433 as shown by way of example in FIG. 10c, or with a spherical penetration end 433 as shown by way of example in FIG. 10d. The rounded penetration end 433 connects the two cutting sections 431, 432.

As shown in FIG. 10c, the cutting sections 431, 432 can extend parallel to one another and be connected via the penetration end 433. As shown by way of example in FIG. 10c, the penetration end 433 can be configured to be rounded in this case. As not explicitly depicted, it can also alternatively be provided that the penetration end 433 is configured to be spherical, as shown in FIG. 10d, with two parallel cutting sections 431, 432.

Alternatively, the cutting sections can form an acute angle as described above. The tip described above thus formed can be formed by a spherical penetration end 433, as shown by way of example in FIG. 10d. As not explicitly depicted, the tip can also be formed by a rounded penetration end 433 in this case, as shown in FIG. 10c.

FIG. 11 shows a perspective view of a cutting device 1, which comprises a conveying device 3, a detection device, a positioning device, a lifting device 9, a first cutting module 4a and a second cutting module 4b.

The detection device comprises a sensor system, which is configured to detect a position of the outer packaging 2 and, if necessary, a length and/or width of the outer packaging 2. The sensor system comprises a light barrier 61 in the example shown. Furthermore, the detection device has a camera system 62 to detect an image of the outer packaging 2 in plan view. As shown in FIG. 11, the camera system 62 is arranged above the conveying device 3.

The first cutting module 4a is arranged downstream of the detection device in the conveying direction F, the former being provided in longitudinal alignment. The first cutting module 4a comprises two cutting systems, each having a movement device 5, on each of which a cutting unit 41 is arranged.

Furthermore, the second cutting module 4b is arranged downstream of the first cutting module 4a in the conveying direction F, the former being provided in transverse alignment. The cutting device 1 depicted is thus is constructed substantially analogously to the cutting device 1 of FIG. 2a and/or FIG. 2b. The second cutting module 4b comprises two cutting systems, each having a movement device 5, on each of which a cutting unit 41 is arranged.

In this case, the first and second cutting module 4a, 4b, the cutting systems, the movement devices 5 and the cutting units 41 are configured as described above.

In the region of the cutting module 4a, the positioning device has a pressing element 8a, which is configured as described above in connection with FIG. 7a.

Furthermore, in the region of the detection device, the positioning device has a positioning unit with opposite positioning means 8b, the positioning unit being configured as described in connection to FIG. 7b. The outer packaging 2 can be positioned and fixed in place for capturing the image with this positioning unit.

Furthermore, in both the region of the first cutting module 4a and in the region of the second cutting module 4b, the positioning device has a positioning unit with opposite positioning means 8b, which are also configured as described above in connection with FIG. 7b. The outer packaging 2 can be positioned and fixed in place when applying the respective cutting paths S1 . . . S4 with these positioning units.

The lifting device 9 is arranged in the region of the second cutting module 4b and comprises a plurality of gripping elements 91, which are configured as clamping grippers, as has been described in connection with FIG. 8a. Of course, the gripping means can also be configured as suction grippers and/or needle grippers, as has been described in connection with FIG. 8b and FIG. 8c.

The positioning device and/or lifting device 9 can also be provided in the same way in a cutting device 1, which is configured as described in connection with FIG. 1a to FIG. 3b.

In addition, the positioning unit comprises a vertically adjustable stop element 8c, for example a stop plate, in the region of the detection unit 6. In this case, the stop element 8c can be movable by means of a drive device between an initial position, in particular below a transport surface of the conveying device 3, and a positioning position, in particular above the transport surface of the conveying device 3. The stop element 8c is arranged in the region of the detection unit 6 in order to position the outer packaging 2 to capture the image. Of course, this can also be provided in a positioning unit, which is arranged in the region of the first and/or second cutting module 4a, 4b. In this case, it can particularly be provided that the stop element 8c interacts with the driving elements 8d as described above in connection with FIG. 7c.

In the example shown, the conveying device 3 is configured as a roller conveyor in the infeed conveying section 31 and in the outfeed conveying section 33 and as a (dual-track) belt conveyor in the cutting module conveying section 32.

In order to transport the outer packaging 2 in a particularly reliable manner, positively acting driving elements 8d are arranged on conveyor belts of the belt conveyor in the example shown, the former being positionable against a side wall of the outer packaging 2. Even if this is only shown in FIG. 11, this can also be provided in other embodiments of the cutting device 1, in particular if this is configured as described in connection with FIG. 1a to FIG. 3b.

Finally, the cutting device 1 can comprise a monitoring device, which has a monitoring sensor system for detecting the outer packaging 2 in the first and/or second cutting position, and which is configured to generate a fault message when the outer packaging 2 is moved from the respective cutting position during application of a cutting path S and/or during lifting of a cut-off collar 22 and/or window cutout 24. In the example shown, the monitoring sensor system comprises a plurality of light barriers 61, which are arranged in the infeed conveying section 31, in the cutting module conveying section 32 and/or in the outfeed conveying section 33. In addition, in the region of the first cutting module 4a and/or of the second cutting module 4b, the monitoring sensor system can comprise an optional ultrasonic sensor, which is arranged below a transport surface of the conveying device 3. The ultrasonic sensor is not explicitly shown in FIG. 11

It is further advantageous for the monitoring device to have a further monitoring sensor system 63, which is configured to detect the collar 22 and/or the window cutout 24 during movement of the collar 22 and/or window cutout 24 from the outer packaging 2. The monitoring sensor system 63 preferably comprises an ultrasonic sensor or a light barrier, whose measuring beam, in particular a light beam, crosses a path movement trajectory of the collar 22 and/or window section 24.

Of course, the monitoring device described in connection with FIG. 11 can also be provided in a cutting device 1, which is configured as described above in connection with FIG. 1a to FIG. 3b.

FIG. 12 schematically depicts a method for applying the circumferential cutting path S in the side walls 21a . . . 21d of an outer packaging 2 filled with goods (W) up to a filling level (H), which can be performed in particular with the cutting device 1 described above.

The method substantially comprises the following steps:
i) providing 100 the outer packaging 2 at the cutting device 1,
ii) determining 110 the cutting height,
iii) moving 120 the outer packaging 2 to the first cutting position,
iv) actuating and aligning 130 the cutting systems,
v) applying 140 a first cutting path pair,
vi) moving 150 the outer packaging 2 to the second cutting position,
vii) actuating and aligning 160 the cutting systems,
viii) applying 170 a second cutting path pair,
ix) lifting 180 the cut-off collar 22 or window cutout 24,
x) transporting 190 the outer packaging 2 from the second cutting position.

For the provision 100 in step i), the outer packaging 2 is transported to the cutting device 1 and transferred to the conveying device 3 of the cutting device 1. This can be performed by a conveyor system of a storage and order-picking system, for example, which connects to the conveying device 3 of the cutting device 1. The provision 100 is performed by means of the conveying device 3 of the cutting device 1.

The determination 110 of the cutting height in step ii) is further performed by the control unit 7 of the cutting device 1. In this case, outer packaging data can be detected, the outer packaging data being determined by the detection unit 6 and/or being read from the electronic memory by the detection unit 6 or the control unit 7 as described above. The filling level H and/or height of the outer packaging 2 is particularly preferably determined in step ii) by means of the camera system 62 and/or the computer system as described above.

During the movement 120 of the outer packaging 2 to the first cutting position in step iii), the outer packaging 2 is transported or moved to the first cutting module 4a by the conveying device 3, in particular by the detection unit 6. The outer packaging 2 is then positioned in the first cutting position, optionally centered on the conveying device 3 and fixed in place by means of the positioning device. In this case, the outer packaging 2 can be fixed in place by means of the pressing element 8a and optionally, as described above, by means of the positioning means 8b, 8c, 8d.

The actuation and alignment 160 of the cutting systems in step iv) is performed by the control unit 7, wherein the cutting systems of the first cutting module 4a are actuated such that these or their cutting units 41 are aligned at the cutting height for applying the first and second cutting path S1, S2 to the first and second side wall 21a, 21b, respectively, or to the cover 23.

The application 170 of first cutting path pair takes place in step v), wherein the cutting elements 43 are moved along the first cutting direction so that, as shown by way of example in FIG. 2a, the first cutting path S1 is applied in the first side wall 21a and the second cutting path S2 in the second side wall 21b, or, as shown by way of example in FIG. 2b, the first and second cutting path S1, S2 are respectively applied in the lid 23. The movement 180 of the outer packaging 2 to the second cutting position is subsequently performed by means of the conveying device 3.

If the cutting device 1 comprises only the first cutting module 4a, as described in connection with FIG. 1a and FIG. 1b, for example, the outer packaging 2 can be rotated 90° about a vertical axis by means of the rotating device 34 and thus brought from the first cutting position into the second cutting position.

If a first cutting module 4a and a second cutting module 4b are provided, which are oriented differently as described in connection with FIG. 2a and FIG. 2b, the outer packaging 2 can be transported by the conveying device 3 from the first cutting module 4a to the second cutting module 4b and provided thereon in the second cutting position, without changing its orientation.

It can further be provided that the first cutting module 4a and the second cutting module 4b are identically oriented as descried above in connection with FIG. 3a and FIG. 3b. In this case, the outer packaging 2 can be transported by the conveying device 3 on the one hand from the first cutting module 4a to the second cutting module 4b and on the other hand be rotated by 90° about a vertical axis by the rotating device 34 and be provided at the second cutting module 4b in the second cutting position.

Regardless of whether only the first cutting module 4a or additionally the second cutting module 4b are provided, the outer packaging 2 is positioned in the second cutting position, optionally centered on the conveying device 3 and fixed in place by means of the positioning device. In this case, the outer packaging 2 can be fixed in place by means of the pressing element Sa and/or by means of the positioning means 8b. The outer packaging 2 can optionally be fixed in place (additionally) by the gripping unit of the lifting device 9 in this case.

The actuation and alignment 160 of the cutting systems in step vii) is performed by the control unit 7. Depending on whether the second cutting position is located in the region of the first cutting module 4a or in the region of the second cutting module 4b, the cutting systems of the first cutting module 4a or of the second cutting module 4b are actuated such that these or their cutting units 41 are aligned at the cutting height for respectively applying the third and fourth cutting path S3, S4 to the third or fourth side wall 21c, 21d or the cover 23.

The application 170 of the second cutting path pair takes place subsequently, wherein the cutting elements 43 are moved along the second cutting direction so that, as shown by way of example in FIG. 2a, the third cutting path S3 is applied in the third side wall 21c and the fourth cutting path S4 in the fourth side wall 21d, or, as shown by way of example in FIG. 2b, the third and fourth cutting path S3, S4 are respectively applied in the lid 23. If only the first cutting module 4a is provided or if the first cutting module 4a and the second cutting module 4b are oriented identically, the second cutting direction can extend parallel to the first cutting direction or be identical thereto. If the first cutting module 4a and the second cutting module 4b are oriented differently, the second cutting direction can form a right angle with the first cutting direction in a horizontal plane.

The outer packaging 2 is preferably fixed in place by the gripping unit of the lifting device 9 in this case.

The lifting 180 of the cut-off collar 22 or the cut-off window cutout 24 subsequently takes place in step ix) in that the gripping unit of the lifting device 9, which holds the cut-off collar 22 or window cutout 24, is moved vertically upward.

If not all regions along the circumferential cutting path S are severed, in particular comer regions, these can be torn off by an upward vertical movement of the gripping unit and severed thus.

If necessary, the collar 22 or window cutout 24 can be transferred to an optional disposal device 10, which is shown schematically by dashed lines in FIG. 2a and FIG. 2b.

Transportation 190 of the outer packaging 2 from the second cutting position subsequently takes place in step x). In this case, the outer packaging 2, which is now open or reduced in height, is essentially removed from the cutting device 1 and transferred back to the conveyor system of the storage and order-picking system, for example.

Thus, the present cutting device 1 or the method described makes it possible for the outer packaging 2 reduced in height, which is adapted to the filling level H and is thus volume optimized, to be closed and shipped to a customer, for example. Alternatively, the outer packaging 2, which is now open, can be emptied at an automated decanting station, for example, the goods W being transferred into a storage container, for example.

Finally, it is stated that the devices shown can, in reality, also comprise more or even fewer components than those shown. In some cases, the devices shown or their components have not been shown to scale and/or enlarged and/or shrunk.

List of reference numerals

| | | | |
|---|---|---|---|
| 1 | Cutting device | 8c | Stop element |
| | | 8d | Driving element |
| 2 | Outer packaging | | |
| 21a . . . 21d | Side wall | 9 | Lifting device |
| 22 | Collar | 91 | Gripping element |
| 23 | Lid | 92 | Clamping surface |
| 24 | Window cutout | 93 | Clamping projection |
| | | 94 | Clamping recess |
| 3 | Conveying device | | |
| 31 | Infeed conveyor section | 10 | Disposal device |
| 32 | Cutting module | | |
| | conveyor section | H | Filling level |
| 33 | Outfeed conveyor section | F | Conveying direction |
| 34 | Rotation device | S, S1 . . . S4 | Cutting path |
| | | W | Goods |
| 4a, 4b | Cutting module | | |
| 41 | Cutting unit | | |
| 42 | Cutting head | | |
| 421 | Base body | | |
| 422 | Cutting element support | | |
| 423 | Connection arrangement | | |
| 43 | Cutting element | | |
| 431, 432 | Cutting section | | |
| 433 | Penetration end | | |
| 44 | Buffer | | |
| 45 | Cutting element | | |
| | drive device | | |
| 46 | Support member | | |
| 47 | Cutting head holder | | |
| 48 | Protective cover | | |
| 49 | Adjusting device | | |
| 5 | Movement device | | |
| 51 . . . 53 | Linear guide unit | | |
| 6 | Detection unit | | |
| 61 | Light barrier | | |
| 62 | Camera system | | |
| 63 | Monitoring sensor system | | |
| 7 | Control unit | | |
| 71 | Electronic memory | | |
| 8a | Pressing element | | |
| 8b | Positioning means | | |

1. A cutting device for applying a substantially circumferential cutting path in an outer packaging filled with goods up to a filling level, the cutting path comprises a first cutting path, a second cutting path, a third cutting path and a fourth cutting path such that the first, second, third and fourth cutting path adjoin one another and form the circumferential cutting path for cutting off a collar and/or window cutout, the cutting device comprises:
a first cutting module having two opposite cutting systems, each with a cutting unit,
wherein the cutting units are movable parallel to a first cutting direction such that cutting paths of the cutting paths, respectively running parallel to one another in pairs, can be applied, and
wherein the cutting units each have a cutting head and a cutting element mounted on the cutting head,
a control unit configured to determine a cutting height to actuate the cutting units such that the circumferential cutting path is applied at the cutting height, and
a positioning device configured to position the outer packaging for applying the first and second cutting path in a first cutting position and for applying the third and fourth cutting path in a second cutting position.

2. The cutting device according to claim 1, wherein the outer packaging has a plurality of side walls, and the cutting device is configured to apply the first cutting path in a first side wall of the side walls and the second cutting path in a second side wall of the side walls, and the third cutting path in a third side wall of the side walls, and the fourth cutting path in a fourth side wall of the side walls, for cutting off the collar, and the cutting units are movable parallel to the first cutting direction such that one cutting path of the cutting paths can respectively be applied in opposite side walls of the outer packaging.

3. The cutting device according to claim 1, wherein the outer packaging has a lid, and the cutting device is configured to apply the first, second, third and fourth cutting path in the lid for cutting off the window cutout.

4. A cutting device for applying a substantially circumferential cutting path in side walls in an outer packaging filled with goods up to a filling level, wherein the cutting device:
is configured to apply a first cutting path in a first side wall of the side walls and a second cutting path in a second side wall of the side walls and a third cutting path in a third side wall of the side walls and a fourth cutting path in a fourth side wall of the side walls, such that the first, second, third and fourth cutting path adjoin one another and form the circumferential cutting path for cutting off a collar,
and a first cutting module, which comprises two opposite cutting systems, each with a cutting unit, wherein the cutting units are movable parallel to a first cutting direction such that a cutting path of the cutting paths can respectively be applied in the opposite side walls of the outer packaging, and
wherein the cutting units each have a cutting head and a cutting element mounted on the cutting head,
wherein the cutting device further has
a control unit for determining a cutting height, which is configured to actuate the cutting units such that the circumferential cutting path is applied at the cutting height, and
a positioning device, which is configured to position the outer packaging for applying the first and second cutting path in a first cutting position and for applying the third and fourth cutting path in a second cutting position.

5. The cutting device according to claim 4, wherein the cutting device comprises a conveying device for transporting the outer packaging in a conveying direction, wherein the conveying device is configured to move the outer packaging to the first cutting position and/or from the first cutting position to the second cutting position.

6. The cutting device according to claim 1, wherein the cutting device has a second cutting module, which comprises two opposite cutting systems, each having a cutting unit, wherein the cutting units are movable parallel to a second cutting direction such that a cutting path of the cutting paths can respectively be applied in the opposite side walls of the outer packaging, wherein the first cutting position is arranged in the region of the first cutting module and the second cutting position is arranged in the region of the second cutting module.

7. The cutting device according to claim 5, wherein the conveying device is configured to transport the outer packaging from the first cutting module to the second cutting module in order to move the outer packaging from the first cutting position to the second cutting position.

8. The cutting device according to claim 7, wherein the conveying device comprises a buffer device with at least one buffer position between the first and second cutting module, on which an outer packaging can be buffered.

9. The cutting device according to claim 1, wherein the first cutting direction and the second cutting direction form a 90° angle.

10. The cutting device according to claim 9, wherein the cutting units are configured to apply the respective cutting path with a penetration depth, wherein the penetration depth corresponds to at least of one wall thickness of the respective side wall or 400% of the wall thickness.

11. The cutting device according to claim 1, wherein the cutting systems each have a movement device on which the respective cutting unit is mounted, wherein the control unit is configured to actuate the movement devices.

12. The cutting device according to claim 1, wherein the control unit is configured to actuate the movement devices such that a receiving width between cutting units of two cutting systems opposite one another is changed.

13. The cutting device according to claim 1, wherein the second cutting position is in an alignment rotated by an angle of 90° about a vertical axis to the first cutting position, and the conveying device comprises a rotating device for rotating the outer packaging about the vertical axis from the first cutting position to the second cutting position.

14. The cutting device according to the claim 1, wherein the cutting device has a detection unit for detecting outer packaging data, the outer packaging data comprising an outer packaging identity, an outer packaging dimension and/or the filling level.

15. The cutting device according to claim 14, wherein the detection unit is connected to the control unit in terms of data in order to transmit the outer packaging data to the control unit, wherein the control unit is configured to determine the cutting height on the basis of the outer packaging data.

16. The cutting device according to claims 1, characterized in that the positioning device comprises a vertically movable pressing element, which can be positioned against the outer packaging from above in order to fix the latter between the pressing element and a transport surface of the conveying device.

17. The cutting device according to claim 1, wherein the positioning device has at least one positioning unit, which comprises two positioning means opposite one another, the positioning means forming contact surfaces facing one another, and the contact surfaces being horizontally movable towards one another and being able to be positioned against opposite side walls of the outer packaging to fix the outer packaging between the contact surfaces.

18. The cutting device according to claim 17, wherein at least one contact means is arranged on each of the contact surfaces, wherein the contact means is configured to create a positive and/or frictional connection between the respective positioning means and the respective side wall.

19. The cutting device according to claim 1, wherein the cutting device further comprises a lifting device, which has a vertically movable gripping unit for lifting the collar and/or the window cutout of the outer packaging.

20. The cutting device according to claim 19, wherein the gripping unit comprises a plurality of gripping elements.

21. The cutting device according to claim 20, wherein at least some of the gripping elements are movably mounted in a horizontal plane.

22. The cutting device according to claim 20, wherein at least some of the gripping elements are configured as clamping grippers.

23. The cutting device according to claim 22, wherein the clamping grippers have two clamping surfaces movable towards one another, wherein on the clamping surfaces, clamping projections and clamping depressions are respectively arranged, which engage one another when the clamping surfaces are moved towards one another.

24. The cutting device according to claim 20, wherein at least some of the gripping elements are configured as needle grippers and/or as suction grippers.

25. The cutting device according to claim 20, wherein the cutting device comprises a disposal device, which is arranged in the operating region of the lifting device, wherein the lifting device is configured to transfer the cut-off collar and/or window cutout to the disposal device.

26. The cutting device according to claim 1, wherein the cutting device comprises a monitoring device, which has a monitoring sensor system for detecting the outer packaging in the first and/or second cutting position, and which is configured to generate a fault message when the outer packaging is moved from the respective cutting position during application of a cutting path and/or during lifting of a cut-off collar and/or window cutout.

27. The cutting device according to claim 1, wherein the control unit is configured to actuate the cutting units such that two opposite cutting units:
are synchronously moved to apply the first and second cutting path, and/or
are synchronously moved to apply the third and fourth cutting path.

28. The cutting device according to claim 1, wherein the cutting systems are automatically operated.

29. A cutting system for an automatically operated cutting device for applying cutting paths, in particular in side walls and/or a lid of an outer packaging, in particular for a cutting device according to claim 1, comprising a movement device and a cutting unit mounted thereon, wherein the cutting unit has a cutting head and a cutting element mounted on the cutting head.

30. The cutting system according to claim 29, wherein the cutting element is configured to be vertically adjustable.

31. The cutting system according to claim 29, wherein the cutting head is mounted on the cutting unit so as to be pivotable about a horizontal axis.

32. The cutting system according to claim 29, wherein a cutting edge of the cutting element comprises a first cutting section and a second cutting section, wherein:
the first cutting section is operative upon movement of the cutting element in a cutting direction, and
the second cutting section is operative upon movement of the cutting element counter to the cutting direction.

33. The cutting system according to claim 29, wherein the cutting head comprises a connection arrangement, a base body arranged on the connection arrangement, and a cutting element support arranged on the base body, the cutting element being mounted on the cutting element support.

34. The cutting system according to claim 33, wherein the cutting unit comprises a cutting head holder, wherein the connection arrangement is arranged on the cutting head holder.

35. The cutting system according to claim 34, wherein the connection arrangement is mounted on the cutting head holder in a horizontally displaceable manner such that the cutting element can be guided along a cutting path curved in a horizontal plane.

36. The cutting system according to claim 35, wherein the connection arrangement is mounted on the cutting head holder via a return spring such that the cutting head:
can be displaced from a first position to a second position when the spring force of the return spring is overcome, wherein the return spring is compressed, and/or
can be displaced from the second position to the first position when the return spring is decompressed.

37. The cutting system according to claim 29, wherein the cutting head comprises a support member, which can be positioned against a side wall of an outer packaging, wherein a normal distance between a vertical tangential plane of a vertex of the cutting element and a contact surface of the support member is constant.

38. The cutting system according to claim 33, wherein the cutting element housing is mounted on the base body of the cutting head via elastic buffers.

39. The cutting system according to claim 34, wherein the base body is mounted on the connection arrangement via elastic buffers.

40. The cutting system according to claim 34, wherein the cutting element is movably mounted on the cutting element support and is driven by a cutting element drive device to perform an oscillating movement relative to the cutting head parallel to the cutting direction.

41. The cutting system according to claim 34, wherein the cutting element is movably mounted on the cutting element support and is driven by a cutting element drive device to perform an oscillating movement relative to the cutting head orthogonal to the cutting direction.

42. The cutting system according to claim 41, wherein the cutting element has a rounded penetration end.

43. The cutting system according to claim 29, wherein the cutting head comprises a protective cover and an adjusting device, wherein the protective cover is movable by the adjusting device between a protective position, in which a cutting edge of the cutting element is covered by the protective cover, and an operating position, in which the cutting edge is exposed.

44. The cutting system according to claim 43, wherein when the adjusting device is activated, the adjusting device is configured to move the protective cover from the protective position into the operating position overcoming a restraining force, and automatically from the operating position into the protective position when deactivated.

45. A method for applying a circumferential cutting path in an outer packaging filled with goods up to a filling level by a cutting device in according to claim 1, comprising the steps:
i) providing the outer packaging at the cutting device,
ii) determining a cutting height, at which the circumferential cutting path is to be applied to the outer packaging by the control unit,
iii) moving the outer packaging to a first cutting position by a conveying device and positioning the outer packaging in the first cutting position by a positioning device,
iv) actuating opposite cutting systems to apply a first cutting path pair, which comprises a first and a second cutting path, by the control unit, wherein the opposite cutting systems each comprise a cutting unit, each having a cutting element, and wherein the cutting elements are aligned at the determined cutting height,
v) applying, parallel to a cutting direction for applying the first cutting path pair,
the first cutting path in the outer packaging by the cutting element aligned at the determined cutting height of step iv), the cutting element being of a first cutting system of the opposite cutting systems for applying the first cutting path pair, and
the second cutting path in the outer packaging by the cutting element aligned at the determined cutting height of step iv), the cutting element being of a second cutting system of the opposite cutting systems for applying the first cutting path pair,
vi) moving the outer packaging from the first cutting position to a second cutting position, in particular by the conveying device, and positioning the outer packaging in the second cutting position by the positioning device,
vii) actuating opposite cutting systems to apply a second cutting path pair, which comprises a third and a fourth cutting path, by the control unit, wherein the opposite cutting systems each comprise a cutting unit, each having a cutting element, and wherein the cutting elements are aligned at the determined cutting height,
viii) applying, parallel to a cutting direction for applying the second cutting path pair,
the third cutting path in the outer packaging by the cutting element aligned at the determined cutting height of step vii), the cutting element being of a first cutting system of the opposite cutting systems for applying the second cutting path pair, and
the fourth cutting path in the outer packaging by the cutting element aligned at the determined cutting height of step vii), the cutting element being of a second cutting system of the opposite cutting systems for applying the second cutting path pair,
such that a first, second, third and fourth cutting path result in a substantially horizontally circumferential cutting path, thereby cutting off a collar or a window cutout of the outer packaging,
ix) lifting the cut-off collar or the window cutout of the outer packaging,
x) transporting the outer packaging from the second cutting position after lifting the collar or the window cutout according to step ix) by the conveying device.

46. The method according to claim 45, wherein in step v), the first cutting path is applied in a first side wall of the outer packaging and the second cutting path in a second side wall of the outer packaging, and in step viii), the third cutting path in a third side wall of the outer packaging and the fourth cutting path in a fourth side wall of the outer packaging.

47. The method according to claim 45, wherein in step v), the first and second cutting path, and in step viii) the third and fourth cutting path is respectively applied in a lid of the outer packaging.

48. A method for applying a circumferential cutting path in side walls of an outer packaging filled with goods up to a filling level by a cutting device, in particular by a cutting device, comprising the steps:
i) providing the outer packaging at the cutting device,
ii) determining a cutting height, at which the circumferential cutting path is to be applied to the outer packaging by a control unit,
iii) moving the outer packaging to a first cutting position by a conveying device and positioning the outer packaging in the first cutting position by a positioning device,
iv) actuating opposite cutting systems to apply a first cutting path pair, which comprises a first and a second cutting path, by the control unit, wherein the opposite cutting systems each comprise a cutting unit, each having a cutting element, and wherein the cutting elements are aligned at the determined cutting height,
v) applying, parallel to a cutting direction for applying the first cutting path pair,
the first cutting path in a first side wall of the outer packaging by the cutting element aligned at the determined cutting height of step iv), the cutting element being of a first cutting system of the opposite cutting systems for applying the first cutting path pair, and
the second cutting path in a second side wall of the outer packaging by the cutting element aligned at the determined cutting height of step iv), the cutting element being of a second cutting system of the opposite cutting systems for applying the first cutting path pair,
vi) moving the outer packaging from the first cutting position to a second cutting position, in particular by the conveying device, and positioning the outer packaging in the second cutting position by the positioning device,
vii) actuating opposite cutting systems to apply a second cutting path pair, which comprises a third and a fourth cutting path, by the control unit, wherein the opposite cutting systems each comprise a cutting unit, each having a cutting element, and wherein the cutting elements are aligned at the determined cutting height,
viii) applying, parallel to a cutting direction for applying the second cutting path pair,
the third cutting path in a third side wall of the outer packaging by the cutting element aligned at the determined cutting height of step vii), the cutting element being of a first cutting system of the opposite cutting systems for applying the second cutting path pair, and
the fourth cutting path in a fourth side wall of the outer packaging by the cutting element aligned at the determined cutting height of step vii), the cutting element being of a second cutting system of the opposite cutting systems for applying the second cutting path pair,
such that the first, second, third and fourth cutting path result in a substantially horizontally circumferential cutting path, thereby cutting off a collar of the outer packaging,
ix) lifting the cut-off collar of the outer packaging, and
x) transporting the outer packaging from the second cutting position after lifting the collar according to step ix) by the conveying device.

49. The method according to claim 48, wherein the outer packaging is rotated about a vertical axis by an angle of 90° by a rotating device of the conveying device during the movement of step vi).

50. The method according to claim 48, wherein the same cutting systems are used in steps iv), v), vii) and viii).

51. The method according to claim 48, wherein during the movement of step vi), the outer packaging is moved by the conveying device from a first cutting module comprising the cutting units for applying the first cutting path pair, to a second cutting module, comprising the cutting units for applying the second cutting path pair.

52. The method according to claim 51, wherein the steps i) to x) are performed for a preceding outer packaging and for a following outer packaging, wherein step iii) is performed for the following outer packaging when the first cutting module is free of the preceding outer packaging.

53. The method according to claim 51, wherein steps i) to x) are performed for a preceding outer packaging and for a following outer packaging,
wherein the step vi) is performed for the following outer packaging when the second cutting module is free of the preceding outer packaging, or
wherein the following outer packaging in step vi) is buffered on a buffer position of a buffer device between the first and second cutting module until the second cutting module is free of the preceding outer packaging.

54. The method according to claim 48, wherein the cutting paths in steps v) and viii) are applied with a penetration depth of the respective cutting element of at least one wall thickness of the respective side wall and/or a maximum of 400% of the wall thickness.

55. The method according to claim 48, wherein determining the cutting height in step ii) comprises detecting outer packaging data by a detection unit, after which the outer packaging data are transmitted to the control unit.

56. The method according to claim 55, wherein the outer packaging and/or an outer packaging type are identified in step ii) on the basis of the detected outer packaging data and outer packaging data assigned to an outer packaging identity and stored in an electronic memory are read.

57. The method according to claim 55, wherein the outer packaging data comprise the filling level and/or an outer packaging dimension, and in step ii), the filling level and/or the outer packaging dimension is detected, after which the cutting height is selected such that it:
is at least at the same level as the filling level or at a level above the filling level, and/or
is below an upper edge of the outer packaging, and/or
is at the height of the lid of the outer packaging.

58. The method according to claim 48, wherein the positioning of the outer packaging in steps iii) and/or vi) comprises fixing the outer packaging in place, wherein a vertically movable pressing element of the positioning device is positioned against the outer packaging from above in order to fix the outer packaging in place between the pressing element and a transport surface of the conveying device.

59. The method according to claim 48, wherein the positioning of the outer packaging in steps iii) and/or vi) comprises fixing the outer packaging in place, wherein opposite side walls of the outer packaging are fixed in place in a clamping manner between two positioning means of the positioning device.

60. The method according to claim 48, wherein lifting the cut-off collar or window cutout in step ix) is automated, wherein the collar or the window cutout is gripped by a gripping unit of a lifting device and lifted by a vertical movement of the gripping unit.

61. The method according to claim 48, wherein lifting the cut-off collar or window cutout in step ix) comprises the severing of regions along the circumferential cutting path, that were not severed when the cutting paths were applied in steps v) and viii), by tearing.

62. The method according to claim 48, characterized in that the outer packaging is retained when the collar or window cutout is lifted in step ix).

63. The method according to claim 48, wherein the cutting elements of the cutting units are moved in an oscillating manner parallel to the respective cutting direction when the cutting paths are applied.

64. The method according to claim 48, wherein the cutting elements of the cutting units are moved in an oscillating manner orthogonal to the respective cutting direction, in particular orthogonal to a surface of the outer packaging to be cut, when the cutting paths are applied.

65. The method according to claim 64, wherein the cutting elements have a spherical penetration end, wherein the goods in the outer packaging are pressed away by the penetration end when the cutting paths are applied and when the respective cutting element penetrates into the outer packaging.

66. The method according to claim 48, wherein a cutting edge of the cutting elements is respectively covered by a protective cover in a protective position while the respective cutting unit is not in use, and the protective cover is moved from the protective position to an operating position in which the cutting edge is exposed by activating an adjusting device, wherein the adjusting device is activated when the respective cutting unit is used to apply a cutting path.

67. The method according to claim 48, wherein the cutting systems are actuated by the control unit such that
cutting heads of the cutting units for applying the first and second cutting paths in step v) are synchronously moved parallel to the cutting direction for applying the first cutting path pair, and/or
cutting heads of the cutting units for applying the third and fourth cutting paths in step viii) are synchronously moved parallel to the cutting direction for applying the second cutting path pair.
